(19) United States
(12) Patent Application Publication
(10) Pub. No.: US 2005/0105027 A1
(43) Pub. Date: May 19, 2005

(54) Optical compensation sheet, polarizing plate and liquid crystal display

(75) Inventors: Minoru Wada, Kanagawa (JP); Ryosuke Miyauchi, Kanagawa (JP)

Correspondence Address: BURNS DOANE SWECKER & MATHIS L L P, POST OFFICE BOX 1404, ALEXANDRIA, VA, 22313-1404, US

(73) Assignee: Fuji Photo Film Co., Ltd., Kanagawa (JP)

(21) Appl. No.: 10/986,199

(22) Filed: Nov. 12, 2004

(30) Foreign Application Priority Data
Nov. 13, 2003 (JP) 2003-383828

(51) Int. Cl. G02F 1/1335

(52) U.S. Cl. 349/117

(57) ABSTRACT

To provide a high-display-quality optical compensation sheet and a liquid crystal display having the optical member without inducing a problem, such as light leakage due to thermal distortion, the optical compensation sheet for a liquid crystal display, the liquid crystal display containing: a liquid crystal cell having a glass plate; and a polarizing plate having the optical compensation film faced to the glass plate, wherein a thickness of the optical compensation sheet, a photoelastic coefficient of the optical compensation and a photoelastic coefficient of the glass plate satisfy the condition specified in the specification.

### BACKGROUND OF THE INVENTION

1. Field of the Invention

The present invention relates to an optical compensation sheet, and to a polarizing plate and a liquid crystal display using the same.

2. Background Art

The liquid crystal display is formed from a polarizing plate and a liquid crystal cell. In relation to a TFT liquid crystal display of TN mode currently in vogue, a liquid crystal display of high display quality is embodied by means of inserting an optical compensation sheet between the polarizing plate and the liquid crystal cell, as described in JP-A-8-50206. However, this method suffers a problem of the liquid crystal display becoming bulky, or the like. JP-A-2-247602 has a description stating that a frontal contrast can be enhanced without increasing the thickness of the liquid crystal display, through use of an elliptical polarizing plate, wherein the elliptical polarizing plate has a retardation plate on one surface of a polarizing layer and a protective film provided on the other surface of the same. However, the retardation film of this invention (i.e., the optical compensation sheet) is found to have a problem in durability, because phase difference is readily caused by thermal distortion or the like. The light leakage (a rise in transmissivity) on the periphery of the polarizing plate is caused by the phase difference, which in turn deteriorates the display quality of the liquid crystal display. In connection with the problem of phase difference arising from distortion, the problem relating to the problem of durability is solved in JP-A-7-191217 and EP 0 911 656 A2 without rendering the liquid crystal display thick, by means of using an optical compensation sheet directly as a protective film of the polarizing plate, wherein an optical anisotropic layer formed from discotic (disk) compounds is applied over a transparent support.

Moreover, in JP-A-2001-264538, the problem relating to durability is solved, by means of adjusting the product of the photoelastic coefficient of the optical compensation sheet and the elastic modulus of the adhesive to 1.2×10⁻⁵ or less. In JP-2001-172542, the problem relating to durability is solved, by means of adjusting the elastic modulus of the adhesive to 0.06 MPa or less. In JP-A-2002-122739, the problem relating to durability is solved, by means of adjusting the product of a linear expansion coefficient of the protective layer in a polarizing plate and the elastic modulus of the adhesive to 1.0×10^{31 5} (° C.⁻¹·MPa) or less. In JP-2002-122740, the problem relating to durability is solved, by means of adjusting the product of a photoelastic coefficient of the polarizing plate protective layer and the elastic modulus of the adhesive to 8.0×10⁻¹²(m²/N·MPa) or less.

Although the polarizing plate using the above-mentioned optical compensation sheet was mounted on a large panel measuring 17 inches or more, the light leakage due to thermal distortion was found not to disappear completely. The optical compensation sheet must have superior durability to withstand changes in use environment, as well as the function of optically compensating the liquid crystal cell.

### SUMMERY OF THE INVENTION

An object of the present invention is to provide a liquid crystal display having high display quality without causing a problem of light leakage due to thermal distortion, or the like, by means of arranging an optical compensation sheet on one side of a polarizing layer and using the optical compensation sheet in a liquid crystal display.

The present inventors conducted thorough diligent examinations, and found that when heat is applied to the liquid crystal panel, phase difference arises in the glass plate of the liquid crystal cell as well as phase difference arises caused by photoelasticity in the optical compensation sheet, and that the phase difference of the glass plate arises in a direction so as to slightly cancel the phase diffrence of the optical compensation sheet, leading to occurrence of light leakage due to thermal distortion.

FIGS. 1 and 2 show an example representing the findings. FIG. 1 shows the quantity of light leakage induced by the above-described thermal distortion when a change has arisen in the photoelastic coefficient of the optical compensation sheet, in the cases where the photoelastic coefficient of the glass plate of the liquid crystal cell is 2.5×10⁻¹² (1/Pa), 3.3×10⁻¹² (1/Pa), and 3.8×10⁻¹² (1/Pa), respectively. As can be seen from the drawing, an excessively large or excessively small photoelastic coefficient of the optical compensation sheet is not suitable for reducing the quantity of light leakage arising from thermal distortion. A balance must be achieved between the photoelastic coefficient of the optical compensation sheet and the photoelastic coefficient of the liquid crystal cell. Moreover, the value of the photoelastic coefficient of the optical compensation sheet is understood to have to be changed in accordance with the photoelastic coefficient of the glass plate of the liquid crystal cell.

FIG. 2 shows the quantity of light leakage caused by the thermal distortion when a change has arisen in the photoelastic coefficient of the optical compensation sheet, in the cases where the optical compensation sheet assumes a thickness of 60 μm, a thickness of 80 μm, and a thickness of 110 μm, respectively. An optimal value of the photoelastic coefficient of the optical compensation sheet is understood to vary in accordance with the thickness of the optical compensation sheet. Achieving the object of the present invention is understood to require setting physical properties such that a balance is achieved between the phase difference arising from photoelasticity of the optical compensation sheet and the phase difference arising in the glass plate of the liquid crystal cell.

Results of examinations show that the light leakage arising from thermal distortion becomes difficult to observe by the naked eye, so long as the quantity of light leakage is adjusted to 0.03% or less, which enables attainment of the object. As a result of thorough diligent examinations, the present inventors found that the object can be attained by the optical compensation sheet having the following configuration, as can be assumed from the drawing.

Specifically, the present invention provides the following optical compensation sheet and the liquid crystal display.

1. An optical compensation sheet for a liquid crystal display, the liquid crystal display comprising: a liquid crystal cell having a glass plate; and a polarizing plate having the optical compensation film faced to the glass plate,
wherein the optical compensation sheet has a thickness by pun and a first photoelastic coefficient by 1/Pa; the glass plate has a second photoelastic coefficient by 1/Pa; and the thickness, the first photoelastic coefficient and the second photoelastic coefficient satisfy a condition that a value Y determined as a result of division of a product of a square root of the thickness and the first photoelastic coefficient by the second photoelastic coefficient is a value of 22 or more and less than 36.

2. The optical compensation sheet according to item 1, which comprises a polymer film.

3. The optical compensation sheet according to item 2, wherein the polymer film comprises a triacetylcellulose film.

4. The optical compensation sheet according to item 2, wherein the polymer film comprises a polymer film of norbornenes.

5. The optical compensation sheet according to item 2, wherein the polymer film comprises a styrenic polymer film.

6. The optical compensation sheet according to item 1, which comprises: a transparent support; and an optical anisotropic layer formed from a liquid crystal compound.

7. A polarizing plate for a liquid crystal display, the liquid crystal display comprising: a liquid crystal cell having a glass plate; and the polarizing plate,
the polarizing plate comprising: a transparent protective film; a polarizing layer; and an optical compensation film an optical compensation film faced to the glass plate in this order,
wherein the optical compensation sheet has a thickness by μm and a first photoelastic coefficient by 1/Pa; the glass plate has a second photoelastic coefficient by 1/Pa; and the thickness, the first photoelastic coefficient and the second photoelastic coefficient satisfy a condition that a value Y determined as a result of division of a product of a square root of the thickness and the first photoelastic coefficient by the second photoelastic coefficient is a value of 22 or more and less than 36.

8. A liquid crystal display, which comprises an optical compensation sheet according to any one of items 1 to 6.

9. A liquid crystal display comprising:
a liquid cell having a glass plate; and
a polarizing layer having an optical compensation film faced to the glass plate,
wherein the optical compensation sheet has a thickness by μm and a first photoelastic coefficient by 1/Pa; the glass plate has a second photoelastic coefficient by 1/Pa; and the thickness, the first photoelastic coefficient and the second photoelastic coefficient satisfy a condition that a value Y determined as a result of division of a product of a square root of the thickness and the first photoelastic coefficient by the second photoelastic coefficient is a value of 22 or more and less than 36.

10. The liquid crystal display according to claim 9, wherein the optical compensation sheet comprises a polymer film.

11. The liquid crystal display according to item 10, wherein the polymer film comprises a triacetylcellulose film.

12. The liquid crystal display according to item 10, wherein the polymer film comprises a polymer film of norbornenes.

13. The liquid crystal display according to item 10, wherein the polymer film comprises a styrenic polymer film.

14. The liquid crystal display according to item 9, which the optical compensation sheet comprises: a transparent support; and an optical anisotropic layer formed from a liquid crystal compound.

15. The liquid crystal display according to item 9, wherein the glass plate comprises at least one selected from the group consisting of quartz glass, pyrex glass, borosilicate glass, vycor glass, soda lime glass, aluminosilicate glass, lead glass, and non-alkali glass.

16. The liquid crystal display according to item 9, wherein the glass plate comprises at least one selected from the group consisting of pyrex glass, borosilicate glass, and aluminosilicate glass.

17. The liquid crystal display according to item 9, which has an light leakage quantity of 0.03% or less.

### ADVANTAGES OF THE INVENTION

The present invention provides a liquid crystal display of high display quality which inhibits occurrence of a frame-like rise in transmissivity due to thermal distortion and prevents occurrence of light leakage, by specifying a value Y determined as a result of division of a product of a square root of a thickness (μm) of the optical compensation sheet and a photoelastic coefficient (1/Pa) of the optical compensation by a photoelastic coefficient (1/Pa) of the glass plate to be a value of 22 or more and less than 36, the optical compensation sheet being faced to the glass plate of the liquid crystal cell.

The present invention can be advantageously used for OCB (Optically Compensatory Bend), VA (Vertically Aligned), IPS (ln Plane Switching), or the like, as well as for the liquid crystal display of TN mode.

### BRIEF DESCRIPTION OF THE DRAWING

FIG. 1 is a graph showing the quantity of light leakage induced by thermal distortion when a change has arisen in the photoelastic coefficient of the optical compensation sheet, in the cases where the photoelastic coefficient of the glass plate of the liquid crystal cell is 2.5×10⁻¹² (1/Pa), 3.3×10⁻¹² (1/Pa), and 3.8×10⁻¹² (1/Pa), respectively.

FIG. 2 is a graph showing the quantity of light leakage caused by thermal distortion when a change has arisen in the photoelastic coefficient of the optical compensation sheet, in the cases where the optical compensation sheet assumes a thickness of 60 μm, a thickness of 80 μm, and a thickness of 110 μm, respectively.

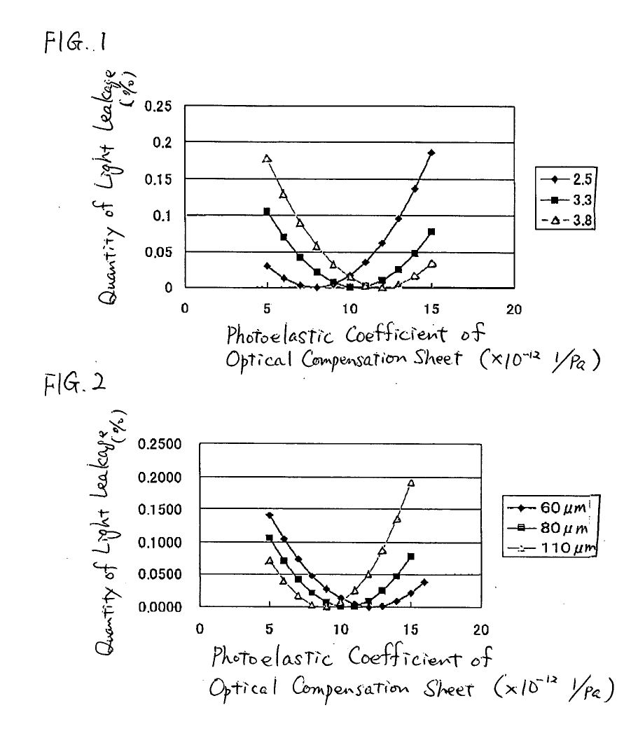

### DETAILED DESCRIPTION OF THE INVENTION

First, the glass plate for the liquid crystal cell of the present invention will be described. The kinds of the glass plate which can be used in the present invention include, for instance, quartz glass (whose photoelastic coefficient is about 3.4×10⁻¹² (1/Pa)); pyrex glass (whose photoelastic coefficient is about 3.8×10⁻¹² (1/Pa)); borosilicate glass (whose photoelastic coefficient is about 3.4×10⁻¹² (1/Pa)); vycor glass (whose photoelastic coefficient is about 3.9×10⁻¹² (1/Pa)), soda lime glass (whose photoelastic coefficient is about 2.5×10⁻¹² (1/Pa)); aluminosilicate glass (whose photoelastic coefficient is about 2.6×10⁻¹² (1/Pa)); lead glass (whose photoelastic coefficient is about 2.6×10⁻¹² (1/Pa)); non-alkali glass or the like (whose photoelastic coefficient is about 2.6×10⁻¹² (1/Pa)), or the like (the kinds of glasses and a method for measuring photoelastic coefficients of the glasses are described in Dictionary of Glass, edited by Sumio SAKUHANA, Asakura-shoten, 1980). When glass of very low photoelastic coefficient is used, compositions such as those described in Komponentabhangigkeit der spaaungsoptischen Koeffizienten von Glas. Glasstech. Ber. 30, 84-88(1957), by Schwiecker are available. However, the glass is not limited to such compositions, and any composition can be used without specific limitations. However, glass containing very few alkaline components is preferable, in view of temporal stability of the liquid crystal. If this is not the case, an alkali barrier layer, such as indium-tin-oxides, is desirably provided on the surface of the glass plate which comes into contact with the liquid crystal.

No limitations are imposed on the elastic modulus of the employed glass. However, an elastic modulus of 4000 kg/mm² is preferable, from the viewpoint of flexure.

The thickness of glass preferably ranges from 0.1 mm to 2 mm, particularly preferably 0.5 mm to 1.5 mm.

Moreover, a low coefficient of thermal expansion is desirable.

Next will be described the polarizing plate of the present invention.

(Polarizing Plate)

The polarizing plate is formed from a polarizing layer, and two transparent protective films provided on the respective sides thereof. An optical compensation sheet to be described later can be used as one of the two protective films. An ordinary polymer film having light transmittance of 80% or more can be used as the other protective film, and a cellulose acetate film can preferably be used as the polymer film. The cellulose acetate film will be described in detail in a Support Section, and its descriptions are applied to the cellulose acetate film.

The polarizing plate of the present invention preferably has a layer structure in which are stacked, in the sequence given, the adhesive layer, the optical compensation sheet, the polarizing layer, and the transparent protective layer. The polarizing plate is mounted on the liquid crystal display via the adhesive layer.

The above-mentioned polarizing layer includes an iodine polarizing layer, a dye polarizing layer using dichromatic dyes, and a polyene polarizing layer. In general, the iodine polarizing layer and the dye polarizing layer are manufactured through use of a polyvinylalcohol film.

Rubber adhesives, acrylic adhesives, and silicon adhesives can be exemplified as the adhesives. Of these adhesives, the acrylic adhesives are desirable, and the weight average molecular weight of base polymer of the acrylic adhesives preferably falls within the range of 300,000 to 2,500,000 or thereabouts.

Various (meta) acrylic esters {(meta) acrylic esters are generic expressions of acrylic esters and methacrylate esters, and compounds prefixed with (meta) hereinafter provide the same meaning} can be used as monomers used for acrylic polymer; that is, base polymer of the acrylic adhesives. For instance, (meta)methyl acrylates, (meta)ethyl acrylates, (meta)acrylate butyls, (meta)2-ethylhexyl acrylates, or the like, can be exemplified as specific examples of such (meta)acrylic esters, and these elements can be used solely or in combination. Moreover, in order to impart polarity to the resultantly-obtained acrylic polymer, a small amount of (meta)acrylic acid can also be used as a substitute of a portion of the (meta)acrylic ester. In addition, (meta)glycidyl acrylates, 2-hydroxyethyl acrylates, and N-methylol(meta) acrylamides can also be used in combination as the crosslinking monomers. If desired, another copolymerizable monomer, such as vinyl acetate or styrene, can be used in combination to such an extent that the adhesive property of the (meta) acrylic ester polymer is not impaired.

A crude rubber, an isoprene rubber, a styrene-butadiene rubber, a reclaimed rubber, a polyisobutylene rubber, a styrene-isoprene-styrene rubber, a styrene-butadiene-styrene rubber, or the like, are illustrated as the base polymer of the rubber adhesives. For instance, dimethylpolysiloxane, diphenyl polysiloxane, and the like are given as the base polymer of the silicone adhesives.

The above-mentioned adhesives can be prepared by means of blending into the base polymer (a) a compound (b) having a molecular weight of 100,000 or less. The proportion (weight ratio) of (a) to (b) is preferably 90:10 to 20:80.

The compound (b) having a molecular weight of 100,000 or less is desirably a substance which exhibits superior compatibility when blended in the base polymer (a); which is optically transparent; and which has a glass transition point (Tg) of 30° C. or more. For instance, there is exemplified a polymer which is analogous to the base polymer having a weight-average molecular weight of 100,000 or less and which uses a large amount of component Tg as a monomer component, or the like.

Moreover, the adhesives can contain a crosslinking agent. A polyisocyanate compound, a polyamine compound, a melamine resin, a urea resin, an epoxy resin, etc. are given as the crosslinking agent. If necessary, a tackifier, a plasticizer, a filler, an oxidation inhibitor, an ultraviolet absorber, or the like, may be appropriately used in the adhesive within the objective of the present invention.

No specific limitations are imposed on a method for forming the adhesive layer on the polarizing plate. Examples thereof include a method for applying an adhesive (solution) to the polarizing plate and drying the adhesive, and a method for transferring an adhesive layer through use of a mold release sheet provided with an adhesive layer.

No particular limitations are imposed on the thickness (dry film thickness) of the adhesive layer, but the thickness is desirably 10 to 40 μm.

The adhesive polarizing plate is obtained by placing the adhesive layer on the surface of the polarizing plate where the optical anisotropic layer is provided.

Next will be described the optical compensation sheet preferably used with the polarizing plate of the present invention.

(Optical Compensation Sheet)

No particular restrictions are imposed on the optical compensation sheet used in the present invention. Any optical compensation sheet can be used, so long as requirements for the value of Y are satisfied. For instance, there can be used a polymer film such as triacetylcellulose, a polymer of norbornenes of a styrenic polymer, or a film having an optically anisotropic layer provided on a transparent support, the layer being formed from a liquid crystal compound.

The optical compensation sheet of the present invention preferably has a photoelastic coefficient of 0 to 20×10⁻¹² (1/Pa).

The optical compensation sheet of the present invention has a thickness of preferably 10 to 200 μm, more preferably 30 to 170 μm. In the present invention, when the optical compensation sheet consists of a single layer (for example, the optical compensation sheet consists of a transparent support), “the thickness” of the optical compensation sheet means a thickness of the singly layer. When the optical compensation sheet comprises multiple layers (for example, the optical compensation sheet comprises: a transparent support; a alignment film; and an optical anisotropic layer), “the thickness” of the optical compensation sheet means a thickness of the transparent support.

(Optical Compensation Sheet and Transparent Support)

Any sheet can be used without particular limitations as the optical compensation polymer sheet or the transparent support of the optical compensation sheet, so long as requirements for the value of Y are satisfied. However, a polymer film having light transmittance of 80% or more is preferable. Examples of the polymer composing the film include cellulose ester (e.g. cellulose acetate, cellulose diacetate and cellulose triacetate (triacetylcellulose)), polyolefin, a cyclicolefine polymer (e.g., a polymer of nolbolnens (hereinafter also called a “norbornene-based polymer)), poly (meta) acrylic ester (e.g., polymethyl methacrylate), polycarbonate, and polysulfone. A commercial polymer (ARTON (manufactured by JSR), ZEONOR (manufactured by Zeon Japan), or the like, in the field of a norbornene-based polymer) may also be employed. Examples of the norbornene-based polymer include ring-opened polymers of norbornenes (including, e.g., norbornenes and compounds formed as a result of a cycloolefin ring being condensed to norbornene), hydrogen addition products thereof, an additive copolymer consisting of norbornenes and ethylene, and the like.

Among the foregoing polymers, cellulose ester is preferable, and lower aliphatic ester in cellulose is more preferable. The lower fatty acid signifies a fatty acid having six carbon atoms or less. The number of carbon atoms is preferably 2 (cellulose acetate), 3 (cellulose propionate), or 4 (cellulose butyrate). Cellulose acetate is particularly desirable. Mixed aliphatic ester, such as cellulose acetate propionate or cellulose acetate butyrate, may also be employed. As for the short chain aliphatic ester of cellulose, a cellulose acetate is most preferable. The degree of acetification of the cellulose acetate preferably falls within a range of 55.0% to 62.5%, more preferably 59.0% to 61.5%. The degree of acetification means the quantity of combined acetic acid per unit weight of cellulose. The degree of acetification complies with measurement and calculation of the degree of acetylation in ASTM D-817-91 (testing method of cellulose acetate, or the like).

The viscosity-average degree of polymerization (DP) of the cellulose acetate is preferably 250 or more, more preferably 290 or more. Moreover, the cellulose ester used for the present invention preferably has a narrow molecular weight distribution of Mw/Mn obtained through gel permeation chromatography (where Mw is a eight-mean molecular weight, and Mn is a number-mean molecular weight). The specific value of Mw/Mn preferably falls within a range of 1.0 to 1.7; more preferably 1.3 to 1.65; and most preferably 1.4 to 1.6.

In general, 2-, 3-, and 6-hydroxyl groups of cellulose acetate are not evenly distributed; i.e., are not distributed in amounts of one-third the entire substitution amount each, and the substitution degree of the sixth hydroxyl group tends to become smaller. In the present invention, the substitution degree of the sixth hydroxyl group of the cellulose acetate is preferably greater than that of the second hydroxyl group and that of the third hydroxyl group. With respect to the entire substitution amount, preferably 30% or more of the sixth hydroxyl group, more preferably 31% or more of the same, and most preferably 32% or more of the same, is substituted by the acetyl group. Moreover, the substitution degree of the sixth acetyl group of the cellulose acetate is 0.88 or more. An optical compensation sheet whose sixth hydroxyl group is replaced by a propionyl group; i.e., an acyl group having three carbons or more, a butyrol group, a valeroyl group, a benzoyl group, or an acryloyl group, rather than by the acetyl group can also be used as the optical compensation sheet of the present invention. The substitution degree at each position can be measured by means of NMR. Examples of the cellulose acetate include a cellulose acetate produced by a method pertaining to Synthesis Example 1 described in paragraph numbers 0043 to 0044 of JP-A-11-5851, a cellulose acetate produced by a method pertaining to Synthesis Example 2 described in paragraph numbers 0048 to 0049, and a cellulose acetate produced by a method pertaining to Synthesis Example 3 described in paragraph numbers 0051 to 0052.

(Retardation Increasing Agent)

In order to adjust retardation of the cellulose acetate film, use of aromatic compounds with at least two aromatic rings as a retardation increasing agent is desirable. The aromatic compound is used within the range of 0.01 to 20 parts by weight with respect to 100 parts by weight of cellulose acetate.

The aromatic compounds are preferably used within the range of 0.05 to 15 parts by weight, more preferably within the range of 0.1 to 10 parts by weight, with respect to 100 parts by weight of cellulose acetate. Two or more types of aromatic compounds may also be used in combination. In addition to including an aromatic hydrocarbon ring, the aromatic ring of the aromatic compound includes an aromatic hetero ring.

Particularly preferably, the aromatic carbon ring is a six-membered ring (i.e., a benzene ring). The aromatic hetero ring is usually an unsaturated hetero ring. The aromatic hetero ring is preferably a five-membered ring, a six-membered ring, or a seven-member ring; more preferably a five-membered ring or a six-membered ring. The aromatic hetero ring usually has the greatest number of double bonds. A nitrogen atom, an oxygen atom, and a sulfur atom are desirable as the hetero atom, with the nitrogen atom being particularly desirable. Examples of the aromatic hetero ring include a furan ring, a thiophene ring, a pyrrole ring, an oxazole ring, an isoxazole ring, a thiazole ring, an isothiazole ring, an imidazole ring, a pyrazole ring, a furazan ring, a triazole ring, a pyran ring, a pyridine ring, a pyridazine ring, a pyrimidine ring, a pyrazine ring, and 1-, 3-, and 5-triazine rings. A benzene ring, a furan ring, a thiophene ring, a pyrrole ring, an oxazole ring, a thiazole ring, an imidazole ring, a triazole ring, a pyridine ring, a pyrimidine ring, a pyrazine ring, and 1-, 3-, and 5-triazine rings are preferable as the aromatic ring. The benzene ring and the 1-, 3-, and 5-triazine rings are more preferable. The aromatic compound particularly preferably has at least one of 1-, 3-, 5-triazine rings.

The number of aromatic rings possessed by the aromatic compound preferably falls within the range of 2 to 20; more preferably 2 to 8; and most preferably 2 to 6.

The bonding relation between two aromatic rings can be classified into a case (a) where a condensed ring is formed; a case (b) where the two aromatic rings are directly connected together by means of a single bond; and a case (c) where the two aromatic rings are connected together by way of a coupling ring (a spiro bond cannot be formed because of the aromatic ring). Any one of the bond relations classified as (a) to (c) may be adopted.

(a) Examples of the condensed ring (a) (condensed rings of two aromatic rings or more) include an indene ring, a naphthalene ring, an azulene ring, a fluorene ring, a phenanthrene ring, an anthracene ring, anacenaphthylene ring, a naphthacene ring, a pyrene ring, an indole ring, an isoindole ring, a benzofuran ring, a benzothiophene ring, an indolizine ring, a benzoxazole ring, a benzothiazole ring, a benzimidazole ring, a benzotriazole ring, a purine ring, an indazole ring, a chromene ring, a quinoline ring, an isoquinoline ring, a quinolizine ring, a quinazoline ring, a cinnoline ring, a quinoxaline ring, a phthalazine ring, a pteridine ring, a carbazole ring, an acridine ring, a phenanthridine ring, a xanthene ring, a phenazine ring, a phenothiazine ring, a phenoxathiin ring, a phenoxazine ring, and a thianthrene. The naphthalene ring, the azulene ring, the indole ring, the benzoxazole ring, the benzothiazole ring, the benzimidazole ring, the benzotriazole ring, and the quinoline ring are desirable.

The single bond classified in the case (b) is preferably a bond between carbon atoms of two aromatic rings. An aliphatic ring or a non-aromatic heterocycle may be formed between two aromatic rings by means of bonding two aromatic rings with two single bonds or more.

The coupling group classified in the case (c) is preferably bonded to carbon atoms of two aromatic rings, as well. The coupling group is preferably an alkylene group, an alkenylene group, an alkynelene group, —CO—, —O—, —NH—, —S—, or combinations thereof. Examples of the coupling group consisting of the combinations are provided below. Positions of the exemplified coupling groups may be switched from one side to the other side.
c1: —CO—O—
c2: —CO—NH—
c3: -alkylene-O—
c4: —NH—CO—NH—
c5: —NH—CO—O—
c6: —O—CO—O—
c7: —O-alkylene-O—
c8: —CO-alkenylene-
c9: —CO-alkenylene-NH—
c10: —CO-alkenylene-O—
c11: -alkylene-CO—O-alkylene-O—CO-alkylene-
c12: —O-alkylene-CO—O-alkylene-O—CO-alkylene-O—
c13: —O—CO-alkylene-CO—O—
c14: —NH—CO-alkenylene-
c15: —O—CO-alkenylene-

The aromatic ring and the coupling group may have a substituent. Examples of the substituent include a halogen atom (F, Cl, Br, I), a hydroxyl group, a carboxyl group, a cyano group, an amino group, a nitro group, a sulfo group, a carbamoyl group, a sulfamoyl group, a ureide group, an alkyl group, an alkenyl group, an alkynyl group, a fatty acyl group, a fatty acyloxy group, an alkoxy group, an alkoxycarbonyl group, an alkoxycarbonylamino group, an alkylthio group, an alkylsulfonyl group, an aliphatic amide group, an aliphatic sulfonamide group, a substituted aliphatic amino group, a substituted aliphatic carbamoyl group, a substituted aliphatic sulfamoyl group, and a substituted aliphatic ureide radical, and a non-aromatic heterocycle group.

In the present specification, even when the hydrogen atom is substituted with atoms other than the hydrogen atom, atoms other than the hydrogen atom are handled as substituents for the sake of convenience.

The number of carbon atoms of the alkyl group desirably falls within the range of 1 to 8. A chain alkyl group is more desirable than a cyclic alkyl group, and a straight-chain alkyl group is especially desirable. The alkyl group may further have a substituent (e.g., hydroxy, carboxy, an alkoxy group, and a substituted alkyl amino group). Examples of the alkyl group (including the substituted alkyl group) include methyl, ethyl, n-butyl, n-hexyl, 2-hydroxyethyl, 4-carboxybutyl, 2-methoxyethyl, and 2-diethylaminoethyl.

The number of carbon atoms of the alkenyl group desirably falls within the range of 2 to 8. A chain alkenyl group is more desirable than a cyclic alkenyl group, and a straight-chain alkenyl group is especially desirable. The alkenyl group may further have a substituent. Examples of the alkenyl group include vinyl, aryl, and 1-hexenyl. The number of carbon atoms of the alkynyl group desirably falls within the range of 2 to 8. A chain alkynyl group is more desirable than a cyclic alkynyl group, and a straight-chain alkynyl group is especially desirable. The alkynyl group may further have a substituent. Examples of the alkynyl group include ethynyl, 1-butynyl, and 1-hyxynyl.

The number of carbon atoms of the aliphatic acyl group desirably falls within the range of 1 to 10. Examples of the acyl group include acetyl, propanoyl, and butanoyl. The number of carbon atoms of the aliphatic acyloxy group desirably falls within the range of 1 to 10. Examples of the acyloxy group include acetoxy. The number of carbon atoms of the alkoxy group desirably falls within the range of 1 to 8. The alkoxy group may further have a substituent (e.g., an alkoxy radical). Examples of the alkoxy group (including the substituted alkoxy group) include methoxyl ethoxy, butoxy, and methoxyethoxy. The number of carbon atoms of the alkoxycarbonyl group desirably falls within the range of 2 to 10. Examples of the alkoxycarbonyl group include methoxycarbonyl and ethoxycarbonyl. The number of carbon atoms of the alkoxycarbonyl amino group desirably falls within the range of 2 to 10. Examples of the alkoxycarbonyl amino group include methoxycarbonyl amino and ethoxycarbonyl amino.

The number of carbon atoms of the alkylthio group desirably falls within the range from 1 to 12. Examples of the alkynylthio group include methylthio, ethynylthio, and octylthio. The number of carbon atoms of the alkynylsulfonyl group desirably falls within the range of 1 to 8. Examples of the alkylsulfonyl group include methanesulphonyl and ethanesulfonyl. The number of carbon atoms of the aliphatic amid group desirably falls within the range of 1 to 10. Examples of the aliphatic amid group include acetamide. The number of carbon atoms of the aliphatic sulfonamide group desirably falls within the range of 1 to 8. Examples of the aliphatic sulfonamide group include methanesulphonamide, butane sulphonamide, and n-octanesulphonamide. The number of carbon atoms of the substituted aliphatic amino group desirably falls within the range of 1 to 10. Examples of the substituted aliphatic amino group include dimethylamino and 2-carboxyethyl amino. The number of carbon atoms of the substituted aliphatic carbamoyl group desirably falls within the range of 2 to 10. Examples of the substituted aliphatic carbamoyl group include methylcarbamoyl and diethylcarbamoyl. The number of carbon atoms of the substituted aliphatic sulfamoyl group desirably falls within the range of 1 to 8. Examples of the substituted aliphatic sulfamoyl group include methylsulfamoyl and diethylsulfamoyl. The number of carbon atoms of the substituted aliphatic ureido group desirably falls within the range of 2 to 10. Examples of the aliphatic ureido group include methylureido. Examples of the non-aromatic heterocycle group include piperidino and morpholino.

The molecular weight of the retardation increasing agent is desirably from 300 from 800. Compounds described in JP-A-2000-111914, JP-A-2000-275434, and PCT/JP00/02619 are enumerated as specific examples of the retardation increasing agent.

(Manufacture of a Cellulose Acetate Film)

Manufacture of the cellulose acetate film through the solvent cast process is preferable. In the solvent cast process, the film is manufactured by means of a solution (dope) prepared by dissolving cellulose acetate into an organic solvent. The organic solvent preferably contains a solvent selected from an ether having 3 to 12 carbon atoms; a ketone having 3 to 12 carbon atoms; an ester having 3 to 12 carbon atoms; and a halogenated hydrocarbon having 1-to 6 carbon atoms. Ether, ketone, and ester may assume a cyclic structure. Compounds having two or more functional groups (i.e., —O—, —CO—, and —COO—) of ether, ketone, and ester can also be used as the organic solvent. The organic solvent may have another functional group such as alcoholic hydroxyl. In the case of an organic solvent having two types of functional groups or more, the only requirement is that the number of carbon atoms should fall within a specified range of a compound having any functional group.

Examples of ethers having 3 to 12 carbon atoms include diisopropyl ether, dimethoxymethane, dimethoxyethane, 1,4-dioxane, 1,3-dioxolane, tetrahydrofuran, anisole, and phenetole. Examples of ketones having 3 to 12 carbon atoms include acetone, methyl ethyl ketone, diethyl ketone, diisobutyl ketone, cyclohexanone, and methylcyclohexanone. Examples of esters having 3 to 12 carbon atoms include ehtyl formate, propyl formate, pentyl formate, methyl acetate, ethyl acetate, and pentyl acetate. Examples of an organic solvent having two or more types of functional groups include 2-ethoxyethyl acetate, 2-methoxy ethanol, and 2-butoxyethanol. The number of carbon atoms of halogenated hydrocarbon is preferably 1 or 2, most preferably 1. Halogen of halogenated hydrocarbon is preferably chlorine. The rate at which hydrogen atoms of halogenated hydrocarbon are substituted with halogen preferably falls within the range of 25 to 75% by mole; more preferably within the range of 35 to 65% by mole; and most preferably within the range of 40 to 60% by mole. Methylene chloride is a typical halogenated hydrocarbon. Two ore more types of organic solvents may also be mixed together.

A solution of cellulose acetate can be prepared by common practice. Common practice means that cellulose acetate is processed at a temperature of 0° C. or more (room temperature or higher). The solution can be prepared through use of a method and apparatus for use in preparing a dope under an ordinary solvent cast method. In the case of the common method, using halogenated hydrocarbon (especially, methylene chloride) as an organic solvent is preferable. The quantity of cellulose acetate is regulated such that 10 to 40% by weight of cellulose acetate is contained in a resultantly-obtained solution. The quantity of cellulose acetate preferably falls within the range of 10 to 30% by weight. An arbitrary additive to be described later may be added to the organic solvent (a principal solvent). The solution can be prepared by stirring cellulose acetate and the organic solvent at room temperature (0 to 40° C.). A high strength solution may be stirred under pressure and heat. Specifically, cellulose acetate and an organic solvent are charged and sealed into a pressurized container and stirred while being heated under pressure to a temperature range which is higher than a boiling point of the solvent at room temperature and at which the solvent does not come to a boil. The heating temperature is usually 40° C., or more, preferably 60 to 200° C., and more preferably 80 to 110° C.

Ingredients may be charged into the container after having been coarsely mixed together. Moreover, the ingredients may be sequentially charged into the container. The container must be constructed so as to enable stirring. The container can be pressurized by injecting an inert gas, such as a nitrogen gas or the like, into the container. Moreover, an increase in vapor pressure of the solvent stemming from heating may also be utilized. Alternatively, the respective ingredients may be added under pressure after the container has been sealed. At the time of heating, the container is preferably heated from the outside. For instance, a heating apparatus of the jacket type can be used. Alternatively, a plate heater may be provided outside the container, and a pipe may be installed on the container, whereby the entire container is heated by circulating a fluid. A stirring impeller is preferably provided in the container, and use of this stirring impeller is preferable. The stirring impeller preferably has such a length that the impeller reaches the vicinity of a wall of the container. A scraping impeller is preferably provided at the end of the stirring impeller for renewing a liquid film on the wall of the container. Instruments, such as a pressure gauge and a thermometer, may be provided in the container.

The individual ingredients are dissolved in the solvent within the container. The prepared dope is taken out of the container after having been cooled or is cooled with a heat exchanger or the like after having been taken out of the container.

The solution can also be prepared by a cooling dissolution method. By means of the cooling dissolution method, cellulose acetate can be dissolved in an organic solvent into which cellulose acetate is difficult to dissolve by means of an ordinary dissolution method. Here, even in the case of a solvent which enables dissolution of cellulose acetate by means of an ordinary dissolution method, the cooling dissolution method yields an effect of immediately production of a uniform solution. Under the cooling dissolution method, cellulose acetate is first gradually added into the organic solvent while being stirred at room temperature. The quantity of cellulose acetate is preferably adjusted such that 10 to 40% by weight of cellulose acetate is contained in the mixture. The quantity of cellulose acetate preferably falls within the range of 10 to 30% by weight. In addition, an arbitrary additive to be described later may be mixed in the mixture.

The mixture is then cooled to fall within the range of −100 to −10° C. (preferably −80 to −10° C., more preferably −50 to −20° C., and most preferably −50 to −30° C.). Cooling can be effected by means of, e.g., a dry ice methanol bath (−175° C.) or a cooled diethylene glycol solution (from −30 to −20° C.). The mixture consisting of cellulose acetate and the organic solvent solidifies by means of such cooling. The cooling speed is preferably 4° C./min. or more, more preferably 8° C./min. or more, and most preferably 12° C./min. or more. The faster the cooling speed, the more desirable. However, 10000° C./sec. is a theoretical ceiling; 1000° C./sec. is a technical ceiling; and 100° C./sec. is a practical ceiling. The cooling speed is a value determined by dividing a difference between a temperature at which cooling is started and a final cooling temperature, by a time lapsing from when cooling is commenced until when a final cooling temperature is reached.

The resultant solid is further heated to 0 to 200° C. (preferably 0 to 150° C., more preferably 0 to 120° C., and most preferably 0 to 50° C.), whereupon cellulose acetate is dissolved in the organic solvent. A temperature rise may be achieved by means of simply leaving the solid at room temperature or heating the solid in a warm bath. The heating speed is preferably 4° C./min. or more, more preferably 8° C./min. or more, and most preferably 12° C./min. or more. A theoretical upper ceiling is 10000° C./sec.; a technical upper ceiling is 1000° C./sec; and a practical ceiling is 100° C./sec. The heating speed is a value determined by dividing a difference between a temperature at which heating is started and a final heating temperature, by a time lapsing from when heating is commenced until when a final heating temperature is reached. A uniform solution is obtained through the foregoing processes. When dissolution is insufficient, cooling and heating operations may be repeated. A determination can be made as to whether or not dissolution is sufficient, by means of observing the appearance of the solution with the naked eye.

Under the cooling solution method, use of an airtight container is desirable from a viewpoint of avoiding intrusion of moisture, which would otherwise be caused by condensation during cooling operation.

Moreover, the dissolution time can be shortened by means of effecting pressurization during the cooling process and effecting decompression during the heating process through the cooling and heating operations. In order to effect pressurization and decompression, use of a pressure-tight container is desirable. In relation to 20% by weight of solution prepared by dissolving cellulose acetate (an acetification degree of 60.9% and viscosity-average polymerization degree of 299) into methyl acetate by means of the cooling dissolution method, a pseudo phase transition point between a sol state and a gel state is found to be located in the vicinity of 33° C. by means of differential scanning calorimetry (DSC), and the solution assumes a uniform gel state at this temperature or below. Therefore, this solution must be maintained at a temperature which is higher than the pseudo phase transition temperature, preferably a temperature which is higher than a gel phase transition temperature by 10° C. or thereabouts. This pseudo phase transition temperature varies according to the acetification degree, the viscosity-average polymerization degree, and the solution concentration of cellulose acetate, as well as according to an organic solvent to be used.

A cellulose acetate film is manufactured from the prepared solution (dope) of cellulose acetate by means of the solvent cast process. Addition of the above-mentioned retardation increasing agent to the dope is desirable. The dope is spread over a drum or a band by means of flow casting, and the film is formed by evaporating the solvent. The concentration of the dope before spreading through flow casting is preferably adjusted such that the quantity of a solid matter assumes a value of 18 to 35%. The surface of the drum or the band is preferably mirror-finished. The flow casting technique and the drying technique of the solvent cast method are described in specifications of U.S. Pat. Nos. 2,336,310, 2,367,603, 2,492,078, 2,492,977, 2,492,978, 2,607,704, 2,739,069, and 2,739,070, and those of British Patent Nos. 640731 and 736892, as well as in JP-B-45-4554, 49-5614, JP-A-60-176834, 60-203430, and 62-115035. The dope is preferably spread over the drum or band whose surface temperature is 10° C. or less, by means of flow casting. The dope is preferably dried upon exposure to wind for two seconds or more after having been spread through flow casting. The thus-obtained film can be scraped off from the drum or band and can be additionally dried with hot wind whose temperature is sequentially changed from 100 to 160° C., thereby evaporating a residual solvent. The above-mentioned method is described in JP-B-5-17844. The time lapsing from the flow casting process to the scraping process can be shortened by this method. In order to fulfill this method, the dope must be gelated at the surface temperature of the drum or band achieved during the flow casting process.

The cellulose acetate solution can also be spread into two or more layers by means of flow casting through use of a prepared cellulose acetate solution (dope), thereby forming a film. In this case, manufacturing the cellulose acetate film by the solvent cast process is preferable. The dope is spread over the drum or band by means of flow casting, and the film is formed by evaporating the solvent. The concentration of the dope before spread through flow casting is preferably adjusted such that the quantity of a solid matter assumes a value of 18 to 35%. The surface of the drum or the band is preferably mirror-finished.

When the cellulose acetate solution is spread into two or more layers; i.e., a plurality of layers, by means of flow casting, a plurality of flows of cellulose acetate solution can be spread by flow casting. A solution containing cellulose acetate may be caused to spread, through flow casting, into layers from a plurality of flow ports provided at intervals in the advancing direction of the support, thereby forming a film. For instance, methods described in JP-A-61-158414, JP-A-1-122419, and JP-A-11-198285 can be used.

Moreover, a film can be formed by means of causing the cellulose acetate solution to flow from two flow ports through flow casting. For example, methods described in JP-B-60-27562, JP-A-61-94724, JP-A-61-947245, JP-A-61-104813, JP-A-61-158413, and JP-A-6-134933 can be used. A method for causing a cellulose acetate film to spread through flow casting described in JP-A-56-162617 can also be used, wherein a flow of high-viscosity cellulose acetate solution is shrouded by a low-viscosity cellulose acetate solution, and the high-viscosity and low-viscosity cellulose acetate solutions are squirted simultaneously.

A film can also be formed by use of two flow ports; scraping a film formed on the support by means of a first flow port; and spreading the solution over the surface of the film facing the surface of the support by means of second flow casting operation. For instance, a method described in JP-B-44-20235 can be given. A single cellulose acetate solution or different cellulose acetate solutions may be used as the cellulose acetate solution to spread by flow casting. In order to impart functions to a plurality of cellulose acetate layers, the only requirement is to squirt cellulose acetate solutions corresponding to the functions from the respective flow ports. The cellulose acetate solution can also be caused to flow by flow casting concurrently with another functional layer (e.g., an adhesive layer, a pigment layer, an anti-static layer, an antihalation layer, a UV absorptive layer, a polarizing layer, or the like).

In the case of a prior-art single-ply solution, a high-viscosity cellulose acetate solution must be squirted in order to achieve a required film thickness.

In this case, the stability of the cellulose acetate solution is poor, and hence solids arise, which induces problems, such as breakdown or a planarity failure. A method for solving this problem is to eject a plurality of flows of cellulose acetate from the flow ports through flow casting. As a result, high-viscosity solutions can be concurrently squired over the support, whereby a planar film having improved planarity can be formed. In addition, a drying load can be diminished through use of a thick cellulose acetate solution, thereby improving a rate at which a film is produced.

In order to improve the mechanical property of the cellulose acetate film, addition of polyesterurethane to the film is preferable. Moreover, polyesterurethane is preferably a reactant of polyester and diisocyanate shown by formula (1) provided below. In addition, polyesterurethane is preferably soluble in dichloromethane.
H—(—O—(CH₂)p-OOC—(CH₂)m-CO)n-O—(CH₂)p-OH Formula (1):

In formula (1), reference symbol “p” represents any integer from 2 to 4; “m” represents any integer from 2 to 4; and “n” represents any integer from 1 to 100.

To be more specific, polyester constituting polyester urethane has, as ingredients, glycol and a dibasic acid. The glycol comprises ethylene glycol, 1,3-propanediol, or 1,4-butanediol. The dibasic acid comprises a succinic acid, a glutaric acid, or an adipic acid; has a hydroxyl group at both ends; and a polymerization degree “n” falling within the range of 1 to 100. The optimum polymerization degree slightly changes according to the type of glycol and dibasic acid, which are to be used, and preferably falls, as the molecular weight of polyester, within the range of 1000 to 4500.

Polyesterurethane resin which is soluble in dichloromethane is a compound which is obtained by a reaction between polyester and diisocyanate expressed formula (1) and which has a repeated unit expressed by formula (2).
CONH—R—NHCO—(O—(CH₂)p-OOC—(CH₂)m-CO)n-O—(CH₂)p-O)— Formula (2):

In formula (2), reference symbol “p” represents any integer from 2 to 4; “m” represents any integer from 2 to 4; “n” represents any integer from 1 to 100; and R represents a bivalent atomic group residue. For instance, an atomic group residue, such as that expressed by the following formula, can be provided as an example of the bivalent atomic group residue.

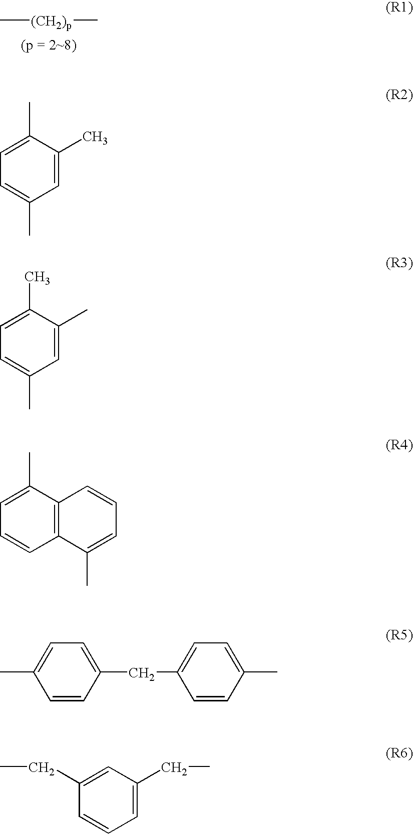

Examples of the ingredient of diisocyanate used in the polyurethane compound include a polymethylene diisocyanate (a formula OCN(CH₂)p NCO(“p” represents any integer from 2 to 8)) typified by ethylene diisocyanate, trimethylene diisocyanate, tetramethylene diisocyanate, hexamethylenediisocyanate, or the like; an aromatic diisocyanate such as p-phenylene diisocyanate, tolylenediisocyanate, p,p′-diphenylmethane diisocyanate, 1,5-naphthylene diisocyanate, or the like; and m-xylylene diisocyanate, etc. However, the ingredient of diisocyanate is not limited to these elements. Of these elements, tolylenediisocyanate, m-xylylene diisocyanate, and tetramethylene diisocyanate are easily available, comparatively stable, and easy to handle. These elements are preferable, in view that the resultant polyurethane has superior compatibility with cellulose acetate when the elements are processed into polyurethane.

The molecular weight of polyesterurethane resin preferably falls within the range of 2,000 to 50,000. The molecular weight is selected appropriately according to the types or molecular weights of ingredients of polyesters or the type or molecular weight of an ingredient of isocyanate which is a group linked to the polyesters. In view of an improvement in the mechanical property of the cellulose acetate film and the compatibility with cellulose acetate, the molecular weight of polyesterurethane resin preferably falls within the range of 5,000 to 15,000. Polyester urethane which is soluble in dichloromethane can be readily obtained, by means of mixing the polyester diols and diisocyanate expressed by formula (1), and stirring and heating the mixture. The polyesters represented by formula (1) can be easily synthesized by appropriately adjusting a terminal group so as to become a hydroxyl group by means of either a thermal fusion condensation method or an interfacial condensation method. The thermal fusion condensation method is based on polyesterification or transesterification arising between an equivalent dibasic acid or alkyl esters thereof and glycols. The interfacial condensation arises between acid chlorides of the dibasic acid and glycols.

A dichloromethane-soluble polyesterurethane resin used in the present invention is highly compatible with cellulose acetate having an acetification degree of 58% or more. Some differences are admitted according to the structure of the resin. However, in the case of polyesterurethane having a molecular weight of 10,000 or less, 200 parts by weight of polyesterurethane are compatible with 100 parts by weight of acetyl cellulose.

Accordingly, when the polyesterurethane resin is mixed with cellulose acetate and when an attempt is made to improve the mechanical properties of a resultant film, it is desirable to appropriately set the content of the polyester urethane resin according to the type, molecular weight, and desired mechanical property of urethane resin. When an attempt is made to improve the mechanical properties of the film while maintaining the characteristics of cellulose acetate, cellulose acetate preferably contains 10 to 50 parts by weight of polyesterurethane resin. Moreover, the polyesterurethane resin is stable and is not thermally decomposed at temperatures up to 180° C., or higher. This dichloromethane-soluble polyesterurethanes is highly compatible with cellulose acetate having an acetification degree of especially 58% or more. Therefore, when an attempt is to produce a film by means of mixing the cellulose acetate and the polyesterurethane, a film having extremely high transparency can be produced. Moreover, in contrast with a conventional low molecular weight plasticizer, these polyesterurethanes have a high mean molecular weight and, hence, do not exhibit any volatility even at high temperature,. Therefore, the film formed from the mixture is less susceptible to problems, which would otherwise be caused during subsequent processing as a result of volatilization of a plasticizer, which has hitherto been observed conventionally, or by transition.

As a result of addition of polyesterurethane to the cellulose acetate film, flexural endurance and tear resistance of the film at high and low temperatures become greater, thereby inhibiting occurrence of a problem, such as tearing of the film. The low molecular weight plasticizer has hitherto been used to improve the flexural endurance and the tear resistance of the film. According to this method, a certain degree of effect is achieved at room temperature and high humidity. However, the flexibility of the film is lost at low temperature and high humidity. Thus, a satisfactory result cannot always be yielded. In addition, when an attempt is made to improve the mechanical properties of the film through use of a low molecular weight plasticizer, mechanical properties, such as tensile strength, are usually decreased considerably with increasing content of the plasticizer. When a dichloromethane-soluble polyesterurethane resin is added to the cellulose acetate, a slight decrease in tensile strength is admitted with increasing resin content. As compared with the case of addition of the low molecular weight plasticizer, a decrease in strength is evidently smaller. There is obtained a strength film having substantially the same flexural endurance as that achieved in the case of addition of no additives. In addition, transition of the plasticizer, which would otherwise arise at low temperature and high humidity, can be prevented, by means of mixing this polyesterurethane. Therefore, there is obtained a transparent, gloss film which does not adhere to another film; which has very high flexibility; and which is not susceptible to crinkling or creaking.

Addition of the previously-described polyesterurethane to the film is preferable, from the viewpoint of improving the mechanical properties of the film. However, any of the following plasticizers can be used in place of or in combination with polyesterurethane. A phosphate ester or carboxylate ester is used as a plasticizer. Examples of phosphate esters include triphenyl phosphate (TPP) and tricresyl phosphate (TCP). Ester-phthalate and citrate ester are typical carboxylate esters. Examples of ester-phthalate include dimethyl phthalate (DMP), diethylphthalate (DEP), dibutylphthalate (DBP), dioctyl phthalate (DOP), diphenyl phthalate (DPP), and diethylhexyl phthalate (DEHP). Examples of citrate esters include O-acetyl citrate triethyl (OACTE) and O-acetyl citrate tributyl (OACTB). Other examples of carboxylate ester include oleic acid butyl, methyl ricinoleate acetyl, dibutyl sebacate, and various trimellitic acid esters. Ester-phthalate-based plasticizers (DMP, DEP, DBP, DOP, DPP, DEHP) are desirably used. DEP and DPP are especially preferable. The desirable content of the plasticizer is preferably 0.1 to 25% by weight of the quantity of cellulose ester; more preferably 1 to 20% by weight, and most preferably 3 to 15% by weight.

An anti-degradation agent (e.g., an anti-oxidant, a peroxide decomposition agent, a radical inhibitor, a metal deactivator, acid trapping agent, or amine) may also be added to the cellulose acetate film. Descriptions about the anti-degradation agent are given in JP-A-3-199201, JP-A-5-1907073, JP-A-5-194789, JP-A-5-271471, and JP-A-6-107854. The content of anti-degradation agent is preferably 0.01 to 1% by weight of a solution (dope) to be prepared, and more preferably 0.01 to 0.2% by weight of the same. When the content is less than 0.01% by weight, the effect of the anti-degradation agent is hardly exerted. When the content exceeds 1% by weight, bleeding out (exudation) of the anti-degradation agent to the surface of the film sometimes occurs. Butylated hydroxytoluene (BHT) and tribenzylamine (TBA) can be enumerated as particularly-preferable examples of anti-degradation agent.

(Biaxial Drawing)

The cellulose acetate film is preferably subjected to drawing in order to reduce virtual distortion. Since virtual distortion in the drawing direction can be diminished by means of drawing, subjecting the film to biaxial drawing for reducing distortion in every direction within a plane is more desirable. Biaxial drawing can be performed by, for example, a simultaneous biaxial drawing method or a sequential biaxial drawing method. From the viewpoint of continuous production, the sequential biaxial drawing method is preferable. After flow of the dope has started, the film is exfoliated from the band or drum and stretched in a widthwise direction (longitudinal direction). Subsequently, the film is stretched in the longitudinal direction (i.e., the widthwise direction). A method for stretching the film in the widthwise direction is described in, e.g., JP-A-62-11503.5, JP-A-4-152125, JP-A-4-284211, JP-A-298310, and JP-A-11-48271.

Drawing of the film is performed at room temperature or under heated conditions. The heating temperature is preferably the glass-transition temperature of the film or less. The film can be drawn during a drying process, which is effective particularly when a solvent is present in the film. In the case of longitudinal stretching of the film, the film is stretched by means of adjusting the speed of a roller for conveying the film such that the speed becomes faster than the speed at which the film is exfoliated. In the case of widthwise drawing of the film, the film can be stretched by means of gradually widening the width of a tenter while the film is transported, with the width of the film being retained by means of the tenter. After having been dried, the film can also be stretched through use of a drawing machine (can preferably be subjected to uniaxial stretching using a long drawing machine) The draw ratio of the film (the ratio of an increase in the length of the film due to stretching to the original length thereof) preferably falls within the range of 5 to 50%, more preferably within the range of 10 to 40%, and most preferably within the range of 15 to 35%.

The process from the film casting process to a post-drying process may be performed in the air or in an inert gas environment, such as nitrogen gas. A take-up machine used for producing cellulose acetate film used in the present invention may be a commonly-used take-up machine. The film can be taken up by means of a constant tension method, a fixed torque method, a tapered tension method, a program tension control method having constant internal stress, or the like.

(Surface Treatment of the Cellulose Acetate Film)

The cellulose acetate film is preferably subjected to surface treatment. Corona discharge treatment, glow discharge treatment, flame treatment, acidizing, the alkali treatment, or UV exposure can be mentioned as specific methods. Moreover, an undercoat is preferably provided, as described in JP-A-7-333433. From the viewpoint of retaining of the planarity of the film, the temperature of the cellulose acetate film is preferably set to a temperature equal to Tg (glass-transition temperature) or less; more specifically, a temperature equal to 150° C. or less, by means of the foregoing processing operations.

When the cellulose acetate film is used as a transparent protective film of the polarizing plate, subjecting the film to acidizing or alkali treatment; that is, subjecting cellulose acetate to saponification, is particularly preferable. Surface energy is preferably 55 mN/m or more, more preferably 60 mN/m to 75 mN/m.

The surface treatment will be specifically described hereunder by means of taking alkaline saponification processing as an example. Alkaline saponification of the cellulose acetate film is preferably performed during a cycle for immersing the surface of the film in an alkaline solution, neutralizing the film with an acidic solution by rinsing the film in water, and drying the film. A potassium hydroxide solution or a sodium hydroxide solution is mentioned as the alkaline solution. The specified concentration of hydroxide ion preferably falls within the range of 0.1 to 3.0 N, more preferably within the range of 0.5 to 2.0 N. The temperature of the alkaline solution preferably falls within the range of room temperature to 90° C., and more preferably within the range of 40 to 70° C.

Surface energy of a solid can be determined by the contact angle technique, the heat of wetting method, or the adsorption method, as described in “Base and application of wetting” (issued by Realize Company, Dec. 10, 1989). In the case of the cellulose acetate film of the present invention, usage of the contact angle technique is preferable. Specifically, two types of solutions, each having known surface energy, are dropped on a cellulose acetate film. At a point of intersection between the surface of the droplet and the surface of the film, the angle including the droplet is defined as a contact angle by means of an angle formed between a tangential line originating from the droplet and the surface of the film. The surface energy of the film can be computed from the thus-measured angle.

(Alignment Film)

The optical compensation sheet used in the polarizing plate of the present invention can formed by means of providing an optical anisotropic layer formed from a liquid crystal compound on a support; preferably, the cellulose acetate film (hereafter, explanations are provided while taking the cellulose acetate film serving as the illustration of the support as a representative of the support) In the present invention, the alignment film (or orientation film) is preferably provided between the cellulose acetate film and the optical anisotropic layer to be provided thereon. The film for the distribution performs the function of aligning (or orienting) the liquid crystal compound used in the present invention in a constant direction. Therefore, the alignment film is indispensable for manufacturing the optical compensation sheet of the present invention. However, if an oriented state of the liquid crystal compound is fixed after the liquid crystal compound has been oriented, the alignment film is not necessarily indispensable as the constituent element of the optical compensation sheet, because the alignment film has already finished playing its role. Specifically, the optical compensation sheet can also be manufactured by means of transferring to the cellulose acetate film only the optical anisotropic layer on the alignment film whose oriented state has been fixed.

The alignment film has the function of specifying the direction of orientation of the liquid crystal compound. The alignment film can be provided by means; for example, rubbing of an organic compound (preferably polymer), orthorhombic deposition of an inorganic compound, formation of a layer having microgrooves, or accumulation of an organic compound (e.g., ω-tricosane acid, dioctadecy methylammonium chloride, and stearyl methyl) employing the Langmuir Blodgett method (LB film). In addition, an alignment film whose orientation function is caused when subjected to an electric field or a magnetic field or when exposed is already known. The alignment film is preferably formed by rubbing of polymer.

The alignment film is preferably formed by rubbing of polymer. Polyvinyl alcohol is preferably used as the polymer. Denatured polyvinyl alcohol whose hydrophobic groups are bound together is particularly preferable. Although the alignment film can also be formed from one type of polymer, forming the alignment film by rubbing a layer consisting of two types of cross-linked polymers is more preferable. Use of crosslinkable polymer or crosslinked polymer as at least one type of polymer is preferable. The alignment film can be formed by means of inducing a reaction between polymers having functional groups or between polymers having introduced functional groups by light, heat, a change in PH, or the like, or by means of introducing binding groups stemming from a crosslinking agent between the polymers through use of a crosslinking agent which is a compound having high reactivity, thereby crosslinking the polymers.

Such crosslinking is carried out by means of applying, on the cellulose acetate film, a coating solution of the alignment film including the polymer, or a mixture of the polymer and the crosslinking agent, and subjecting the coating to heating or the like. The only requirement is that the durability of the optical compensation sheet is ensured. Hence, crosslinking may be performed during any of the processes from the process for applying the alignment film on the cellulose acetate film to the process for acquiring the optical compensation sheet. When consideration is given to the orientation property of the layer (the optical anisotropic layer) formed from a liquid crystal compound on the alignment film, performing sufficient crosslinking after orientation of the liquid crystal compound is also preferable. The crosslink of the alignment film is generally formed by applying the alignment film coating over the cellulose acetate film, and heating and drying the coating. The alignment film is preferably sufficiently crosslinked in a heating stage for forming an optical anisotropic layer to be described layer, by means of setting the temperature for heating the coating.

Either crosslinkable polymer or polymer to be crosslinked through use of a crosslinking agent can be used as polymer to be used for the alignment film. As a matter of course, some polymers can be used as both the crosslinkable polymer and the polymer to be crosslinked through use of a crosslinking agent. Examples of polymer include polymethyl methacrylate, an acrylic/methacrylic copolymer, a styrene/maleinimide copolymer, polyvinyl alcohol, denatured polyvinyl alcohol, poly(N-methylolacrylamide), a styrene/vinyltoluene copolymer, chlorosulfonated polyethylene, nitrocellulose, polyvinyl chloride, chlorinated polyolefin, polyester, polyimide, a vinyl acetate/vinyl chloride copolymer, an ethylene/vinyl acetate copolymer, carboxymethyl cellulose, polyethylene, polypropylene, polymers such as polycarbonate, a silane coupling agent, or the like.

Preferred examples of the polymer include poly (N-methylolacrylamide), carboxymethyl cellulose, gelatin, and water-soluble polymers such as polyvinyl alcohol and denatured polyvinyl alcohol. Use of gelatin, polyvinyl alcohol, and denatured polyvinyl alcohol is preferable, and use of polyvinyl alcohol and denatured polyvinyl alcohol is more preferable. Moreover, concurrent use of two types of polyvinyl alcohols or denatured polyvinyl alcohols having different polymerization degrees is most preferable.

Polyvinyl alcohol whose saponification level falls within the range of 70 to 100% is mentioned as an example of polyvinyl alcohol. In general, the saponification level falls within the range of 80 to 100%, more preferably within the range of 85 to 95%. The polymerization degree of polyvinyl alcohol preferably falls within the range of 100 to 3000. Polyvinyl alcohol denatured by copolymerization denaturization/chain transfer or by block polymerization can be illustrated as an example of denatured polyvinyl alcohol. COONa, Si(OX)₃, N(CH₃)₃Cl, C₉H₁₉COO, SO₃, Na, and C₁₂H₂5, etc. are enumerated as examples of a degenerative radical required when polyvinyl alcohol is denatured by copolymerization. COONa, SH, and C₁₂H₂₅, etc. are enumerated as examples of the degenerative radical required when polyvinyl alcohol is denatured by chain transfer. Moreover, COOH, CONH₂, COOR, and C₆H₅, etc. are enumerated as examples of the degenerative radical required when polyvinyl alcohol is denatured by block polymerization. Of the polyvinyl alcohols, undenatured or denatured polyvinyl alcohol having a saponification level of 80 to 100% is preferable. Moreover, undenatured polyvinyl alcohol and denatured polyvinyl alcohol having a saponification level of 85 to 95% are more preferable

A substance produced as a result of polyvinyl alcohol being denatured by a compound expressed by the following formula is particularly preferable as the denatured polyvinyl alcohol. This denatured polyvinyl alcohol is hereinafter described as specific denatured polyvinyl alcohol.

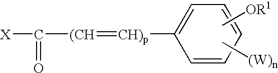

R¹ in the formula represents an alkyl group, an acryloyl alkyl group, a methacryloyl alkyl group, or an epoxy alkyl group; W represents a halogen atom, an alkyl group, or an alkoxy group; X represents an atomic group necessary to form active ester, acid anhydride, or acid halide; “p” is 0 or 1; and “n” is an integer from 0 to 4. The above-mentioned specific denatured polyvinyl alcohol is preferably a natured substance of polyvinyl alcohol consisting of the compound represented by the following formula.

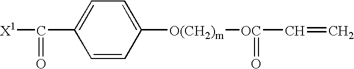

X¹ in the formula represents an atomic group required to form active ester, acid anhydride, or acid halide, and “m” is an integer from 2 to 24.

Denatured substances of polyvinyl alcohol, such as the previously-described undenatured polyvinyl alcohol, polyvinyl alcohol denatured by copolymerization, i.e., polyvinyl alcohol denatured by chain transfer, and polyvinyl alcohol denatured by block polymerizataion, can be mentioned as polyvinyl alcohol to be used for reacting with the compound represented by the formula. A preferred example of the specific denatured polyvinyl alcohol is described in detail in JP-A-9-152509. A method for synthesizing these polymers, measurement of visible absorption spectra, and a method for determining the rate of introduction of denatured radicals, or the like, are described in detail in JP-A-8-338913.

Aldehydes, N-methylol compounds, dioxane derivatives, compounds which work by activating a carboxyl group, an active vinyl compound, an active halogen compound, isoxazoles, and dialdehyde starch can be enumerated as examples of the crosslinking agent. Formaldehyde, glyoxal, and glutaraldehyde are enumerated as examples of aldehydes. Dimethylolurea and methylol dimethyl hydantoin are enumerated as examples of the N-methylol compound. 2,3-dihydroxy dioxane is enumerated as an example of the dioxane derivative. Examples of the compound which works by activating the carboxyl group include carbenium, 2-naphtalenesulfonate, 1,1-bispyrrolidino-1-chloropyridinium, and 1-morpholino carbonyl-3-(sulfonato aminomethyl). Examples of the active vinyl compound include 1,3,5-triacroyl-hexahydro-s-triazine, bis(vinyl sulfone)methane, and N,N3-methylenebis-(β-((vinyl sulfonyl)propionamide). 2.4-dichloro-6-hydroxy-S-triazine is mentioned as an example of the active halogen compound. These compounds can be used by alone or in combination. These compounds are preferable particularly when used in conjunction with polyvinyl alcohol and denatured polyvinyl alcohol (including the foregoing specific denatured substances) When consideration is given to productivity, use of aldehydes having high reaction activity, in particular, use of glutaraldehyde is a preferable.

No special limitations are imposed on the quantity of crosslinking agent added to polymer. Moisture resistance tends to become improved with an increase in the quantity of crosslinking agent to be added. However, when 50% by weight of crosslinking agent or more is added to polymer, the orientation performance of the alignment film is decreased. Therefore, the quantity of crosslinking agent to be added to polymer falls preferably within the range of 0.1 to 20% by weight and more preferably within the range of 0.5 to 15% by weight. Although the alignment film includes a crosslinking agent having not reacted to a certain extent even after completion of the crosslinking reaction, the quantity of crosslinking agent included in the alignment film is preferably 1.0% by weight or less and more preferably 0.5% by weight or less. When the crosslinking agent which has not reacted is contained in excess of 1.0% by weight in the alignment film, sufficient durability is not obtained. Specifically, under a situation where the alignment film is used in the liquid crystal device, when the alignment film is used over a long period of time or left in a high-temperature and high-humidity environment for a long period of time, reticulation often arises.

The alignment film can be formed by means of applying a solution containing the polymer or a solution containing the polymer and the crosslinking agent over the cellulose acetate film, baking (crosslinking) the solution, and rubbing the film. The crosslinking reaction may arise during an arbitrary period after application of the coating over the cellulose acetate film. When water-soluble polymer, such as polyvinyl alcohol, is used as a material for preparing an alignment film, a solvent used for making the coating is preferably an organic solvent having a defoaming action, such as methanol, or a mixed solvent consisting of an organic solvent and water. When methanol is used as the organic solvent, the weight ratio of water to methanol is usually 0:100 to 99.land more preferably 0:100 to 91:9. As a result, occurrence of foam is suppressed, and occurrence of defects in the surface of the alignment film, in particular, the surface of the optical anisotropic layer, is considerably reduced.

A spin coating method, a dip coating method, a curtain coating method, an extrusion coating method, a bar coating method, and an E-type application method can be enumerated as the coating method. Among of them, the E-type application method is particularly preferable.

The thickness of the alignment film preferably falls within the range of 0.1 to 10 μm. Baking can be performed within the heating temperature range of 20 to 110° C. In order to make a sufficient crosslink, the heating temperature preferably falls within the range of 60 to 100° C. and more preferably within the range of 80 to 100° C. Drying can be performed in one minute to 36 hours. Preferably, drying can be performed in 5 to 30 minutes. Setting pH to a value optimum for a crosslinking agent to be used is desirable. When glutaraldehyde is used, pH preferably falls within the range of 4.5 to 5.5, and pH is ore preferably set to 5.

A processing method widely adopted in a process for orienting liquid crystal of a liquid crystal device can be utilized for the rubbing process. Specifically, there can be adopted a method in which the surface of the alignment film is rubbed in a given direction through use of paper, gauze, a felt, rubber, nylon, polyester fibers, etc., to thus acquire alignment of the film. In general, orientation is effected by means of rubbing an alignment film several times through use of a cloth to which fibers having uniform length and thickness are transplanted.

(Optical Anisotropic Layer)

In the present invention, the optical anisotropic layer consisting of the liquid crystal compound is formed on the alignment film provided on the cellulose acetate film. The liquid crystal compound used in the optical anisotropic layer includes a rod-like liquid crystal compound or a discotic liquid crystal compound. The rod-like liquid crystal compound and the discotic liquid crystal compound may be polymeric or low-molecular-weight liquid crystal and further includes a liquid crystal compound which has not exhibited a liquid crystal property as a result of crosslinking of low-molecular-weight liquid crystals. The optical anisotropic layer can be formed by applying, over the alignment film, a coating containing a liquid crystal compound and, if necessary, a polymeric initiator and an arbitrary component.

An organic solvent is preferably used a solvent to be used for preparing the coating. Embodiments of the organic solvent include amid (e.g., N,N-dimethylformamide), sulfoxides (e.g., dimethyl-sulfoxide), a heterocyclic compound (e.g., pyridine), hydrocarbons (e.g., benzene and hexane), alkyl halides (e.g., chloroform, dichloromethane, and tetrachloroethane), esters (e.g., methyl acetate and butyl acetate), ketones (e.g., acetone, methyl ethyl ketone), and ethers (e.g., tetrahydrofuran, 1,2-dimethoxyethanes). Alkyl halide and the ketone are preferable. Two types of organic solvents or more may be used concurrently. The coating can be applied by means of a known method (e.g., a wire bar coating method, an extrusion coating method, a direct gravure coating method, a reverse gravure coating method, or a die coating method).

The thickness of the optical anisotropic layer falls preferably within the range of 0.1 to 20 μm, more preferably within the range of 0.5 to 15 μm, and most preferably within the range of 1 to 10 μm. Use of the discotic liquid crystal compound is preferable as the liquid crystal compound to be used in the present invention.

(Rod-Like Liquid Crystal Compound)

Preferably used as the rod-like liquid crystal compound are azomethines, azoxies, cyanobiphenyls, cyanophenyl esters, benzoates, cyclohexanecarboxylic acid phenyl esters, cyanophenyl cyclohexanes, cyano-substituted phenylpyrimidines, alkoxy-substituted phenyl pyrimidines, phenyl dioxanes, tolanes, and alkenyl cyclohexyl benzonitriles. A metal complex is included in the rod-like liquid crystal compound. Moreover, the liquid crystalline polymer containing a rod-like liquid crystal compound in the repetitive unit can also be used as a rod-like liquid crystal compound. Put another way, the rod-like liquid crystal compound may be bonded to (liquid crystal) polymer. The rod-like liquid crystal compound is described in Chapters 4, 7, and 11 of Quarterly-Chemical Introduction (1994) edited by the Chemical Society of Japan, Volume 2 and in Chapter 3 of Liquid Crystal Device Handbook edited by the 142nd committee of Japan Society for the Promotion of Science. The birefringence of rod-like liquid crystal compound preferably falls within the range of 0.001 to 0.7. In order to fix the oriented state, the rod-like liquid crystal compound preferably has polymeric radicals. An example of the polymeric radical (Q) is shown below.

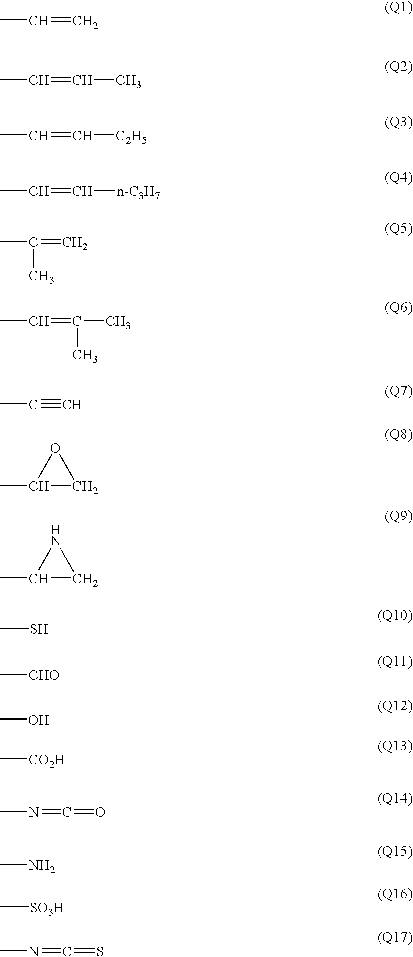

The polymeric radicals (Q) are preferably unsaturated polymeric radicals (Q1 to Q7), epoxy radicals (Q8), or aziridinyl radicals (Q9), and more preferably unsaturated polymeric radicals. Most preferably, the polymeric radicals are ethylene unsaturated polymeric radicals (Q1 to Q6). The rod-like liquid crystal compound preferably has the molecular structure which is substantially symmetric with respect to the direction of a short axis. Therefore, the rodlike molecule structure preferably has a polymeric radical at both ends thereof. Examples of the rod-like liquid crystal compound are shown below.

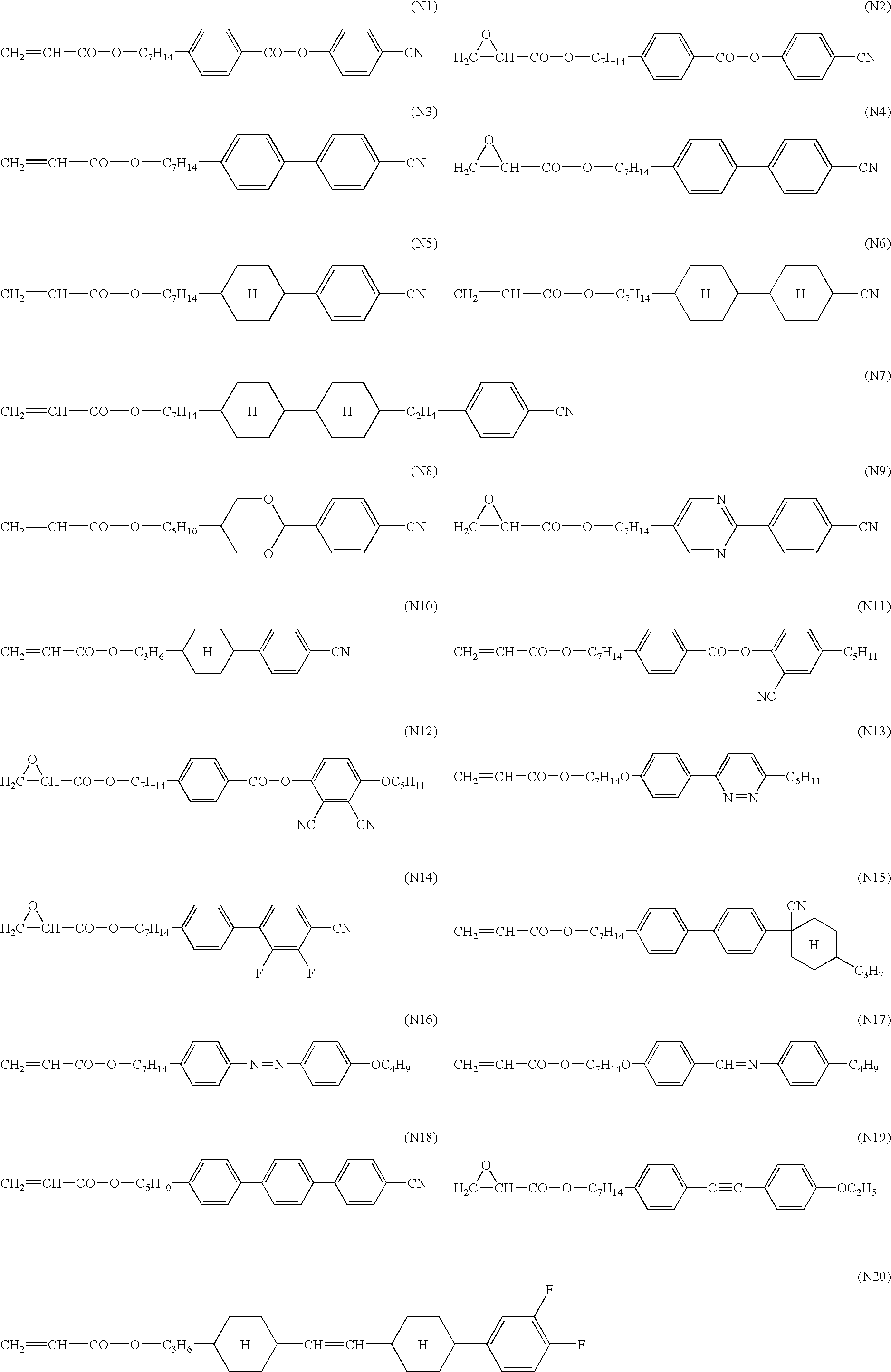

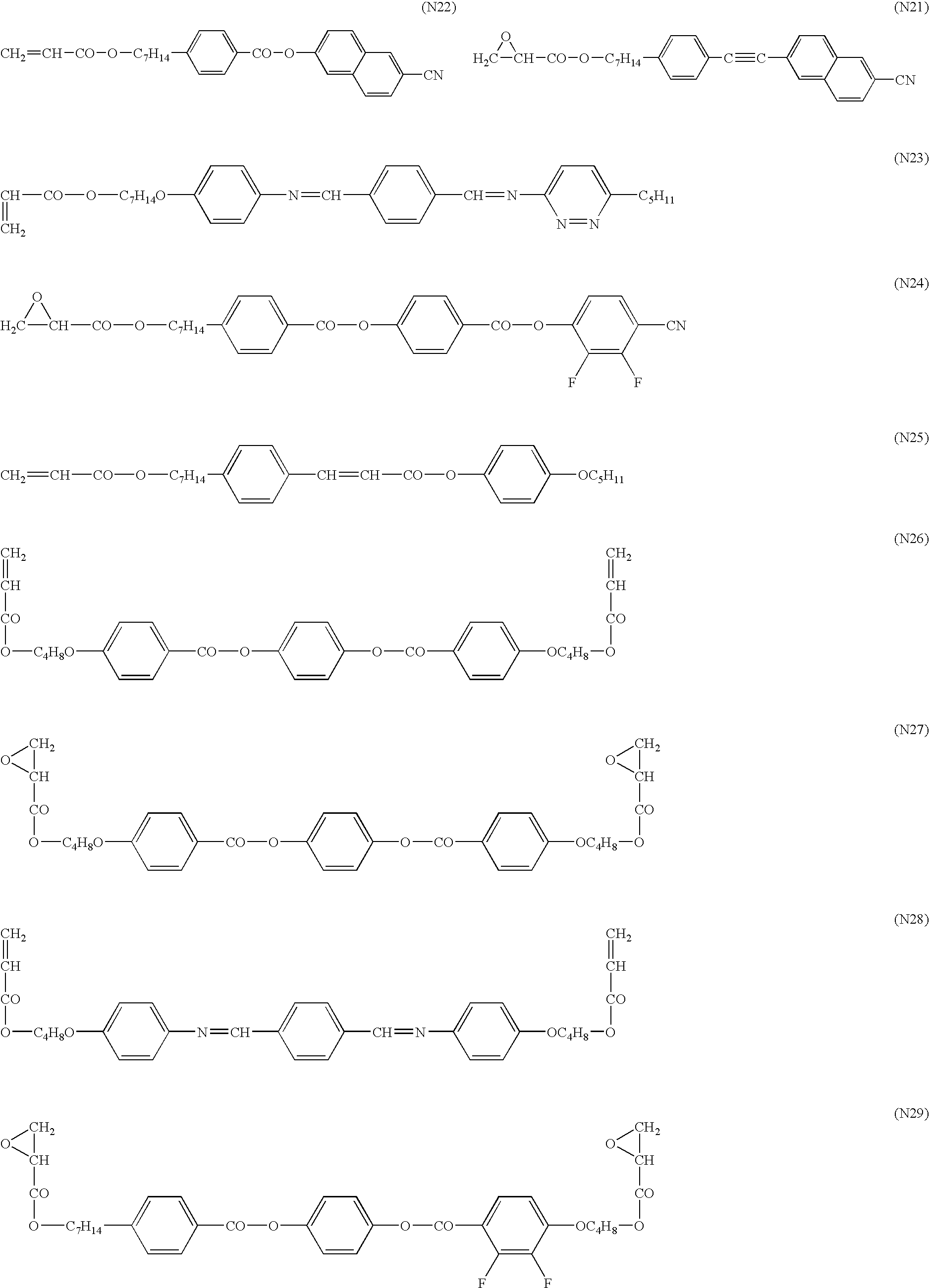

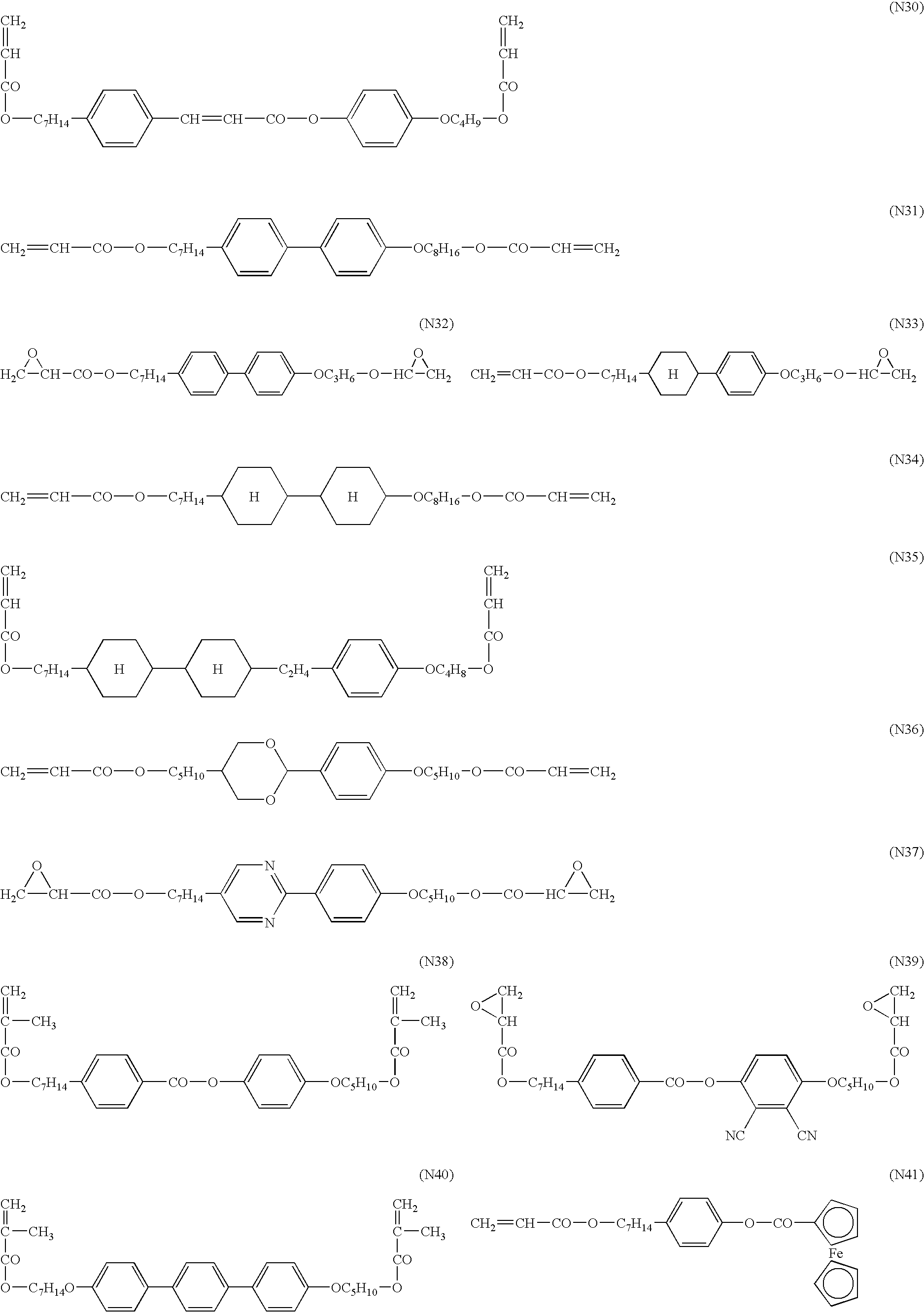

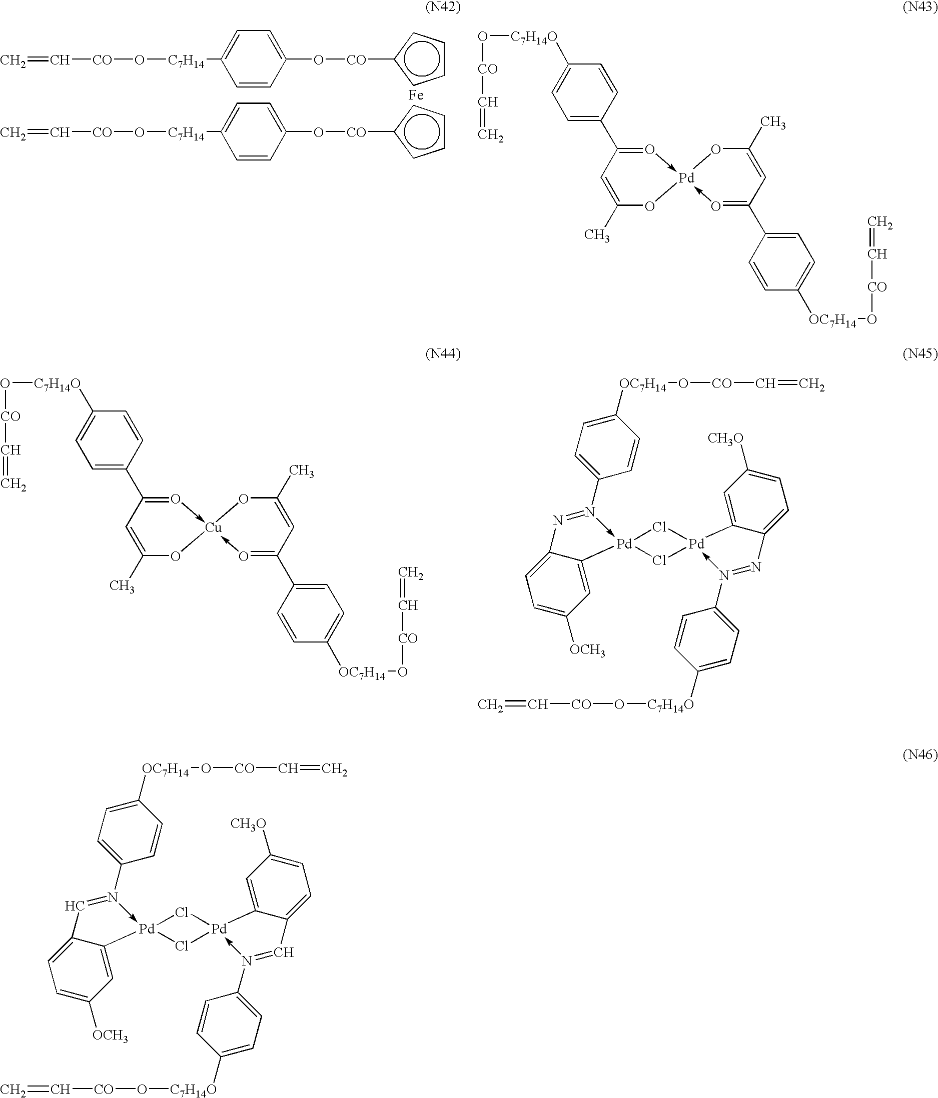

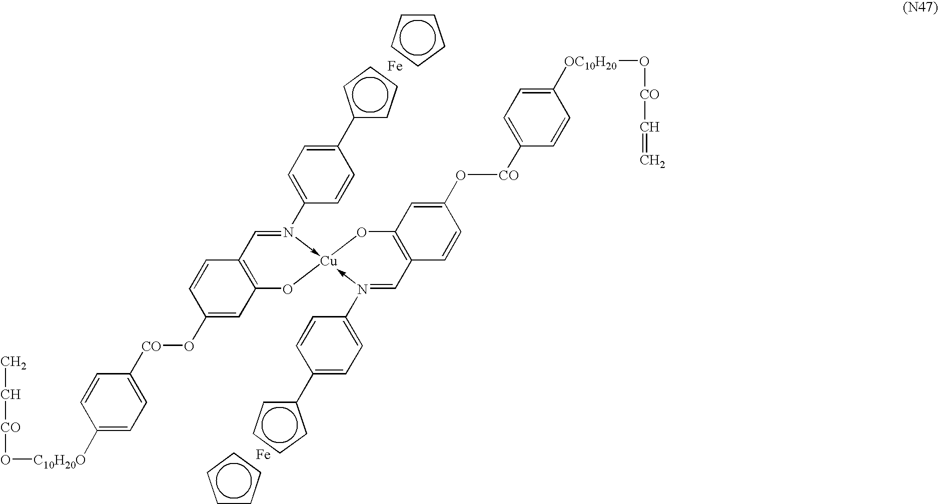

The optical anisotropic layer can be formed by means of applying the rod-like liquid crystal compound or a polymeric initiator to be described later, and an arbitrary additive (e.g., plasticizer, monomer, a surface active agent, cellulose ester, 1,3,5-triazine compounds, or a chiral agent) over the alignment film.

(Discotic Liquid Crystal Compound)

Examples of the discotic liquid crystal compound include a benzene derivative described on pg. 111 of Research Report Mol. Cryst. by C Destrade et al., Vol. 71 (1981); a toluxene derivative described on pg. 141 of Research Report Mol. Cryst. by C Destrade et al., Vol. 122 (1985) and pg. 82 of Phyiscs lett., A, Vol. 78 (1990); a cyclohexane derivative described on pg. 70 of Research Paper Angew. Chem. by B. Kohne et al. Vol. 96 (1984); and an azacrown-based or phenylacetylene-based macrocycle described on pg. 1794 of Research Report J. Chem. Commun., by J. M. Lehen et al, (1985) and on pg. 2655 of Research Report J. Am. Achem. Soc. by J. Zhang et. al. Vol. 116 (1994). In general, the discotic liquid crystal compound also includes a compound which takes any of the foregoing derivative as a nuclear of molecules and which has a structure radially replaced with straight-line alkyl or alkoxygroup, a substituted benzyloxy group, or the like, as a straight line; and exhibits a liquid crystal property. The discotic liquid crystal compound is not limited to those mentioned above, so long as molecules possess a negative uniaxial property and can impart given orientation. Moreover, in the present invention, the optical anisotropic layer finally formed from the discotic liquid-crystal compound does not need to be any of the foregoing compounds. For instance, the optical anisotropic layer includes a low-molecular-weight discotic liquid crystal compound having a group which causes reaction upon exposure to heat, light, or the like. The compound induces reaction upon exposure to heat, light, or the like, and is consequently subjected to polymerization or crosslinking, to thus assume a high molecular weight and lose the liquid crystal property. A preferred example of the discotic liquid crystal compound is described in JP-A-8-50206. Moreover, polymerization of the discotic liquid crystal compound is described in JP-A-8-27284.

In order to fix the discotic liquid crystal compound, a polymeric radical must be bound as a substituent to a disk-shaped core of the discotic liquid crystal compound. However, when the polymeric radical is connected directly with the disk-shaped core, maintaining the orientated state becomes difficult for reasons of polymerization reaction. A coupling group is introduced between the disk-shaped core and the polymeric radical. Therefore, the discotic liquid crystal compound having a polymeric radical is preferably any of compounds represented by formula (3) provided below.
D(-L-P)n Formula (3):

In formula (3), D is a disk-shaped core; L is a bivalent coupling group; P is a polymeric radical; and “n” is an integer from 4 to 12. An example of the disk-shaped core (D) is shown below. In the following respective examples, LP (or PL) means the combination of a bivalent coupling group (L) and the polymeric radical (P).

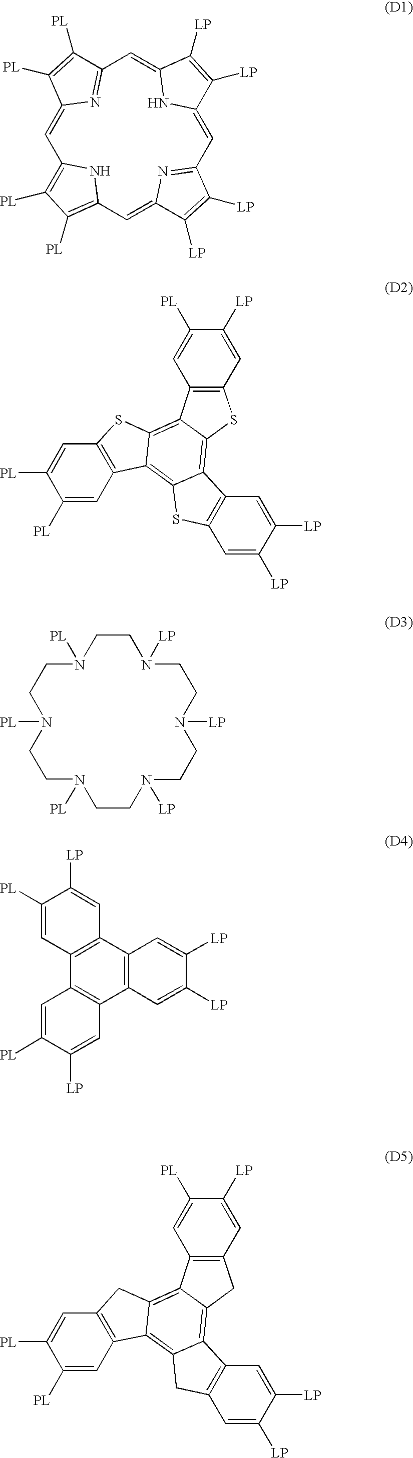

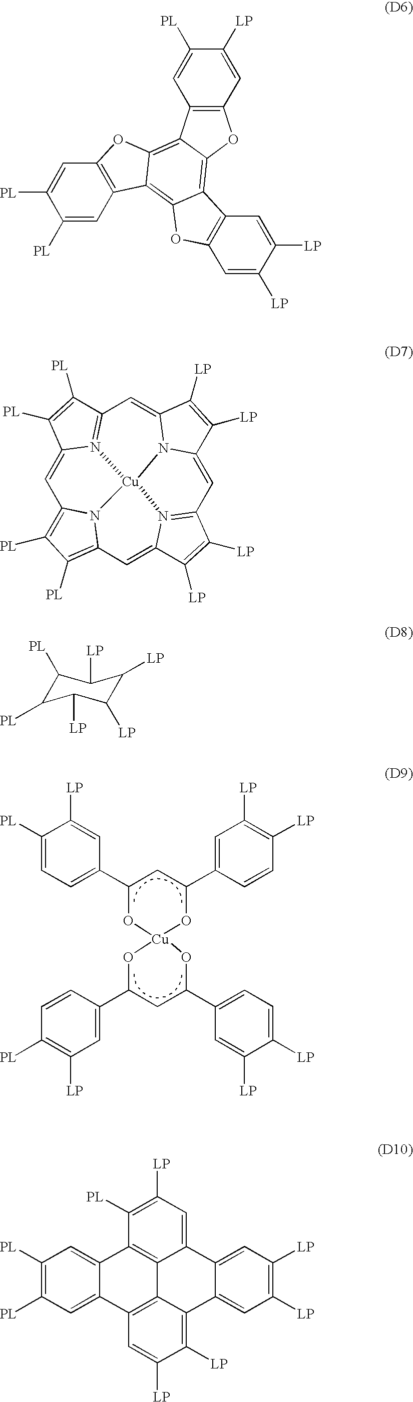

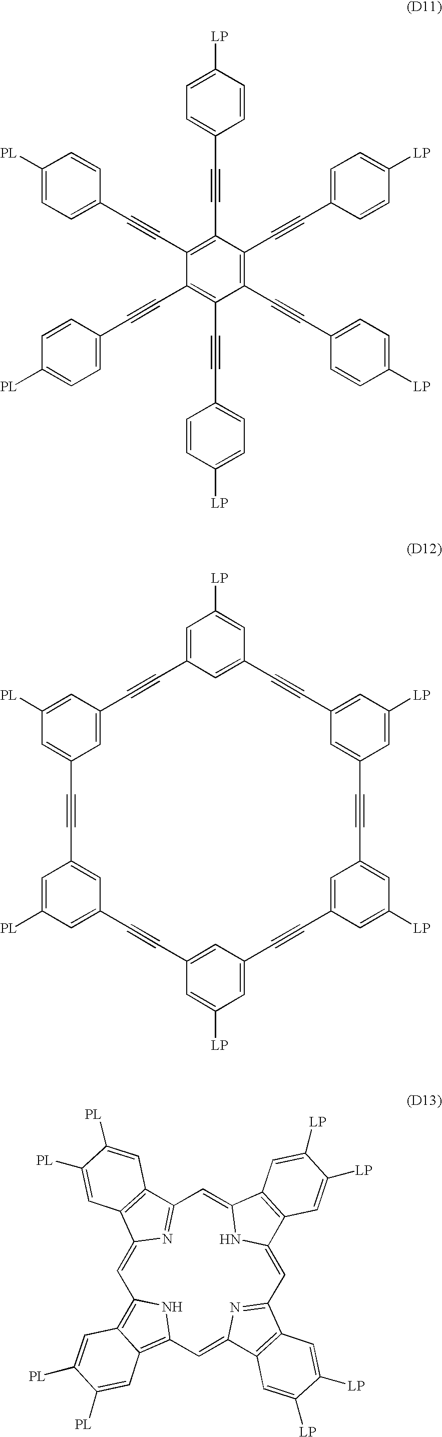

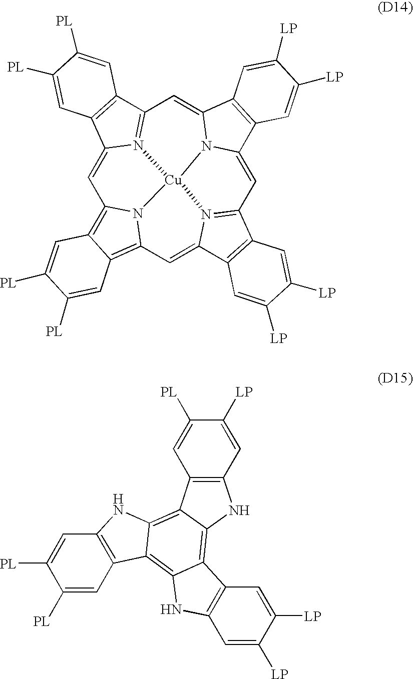

In formula (3), the bivalent coupling group (L) is preferably a bivalent coupling group selected from the group comprising an alkylene group, an alkenylene group, an arylene group, —CO—, —NH—, —O—, —S—, and combinations thereof. The bivalent coupling group (L) is more preferably a bivalent coupling group formed by combination of at least two bivalent groups selected from the group comprising an alkylene group, an arylene group, —CO—, —NH—, —O—and —S—. The bivalent coupling group (L) is most preferably a bivalent coupling group formed by combination of at least two bivalent groups selected from the group comprising an alkylene group, an arylene group, —CO—, and —O—. The number of carbon atoms of the alkylene group desirably falls within the range from 1 to 12. The number of carbon atoms of the alkenylene group desirably falls within the range from 2 to 12. The number of carbon atoms of the arylene group desirably falls within the range from 6 to 10.

An example of the bivalent coupling group (L) is shown below. The left-side of the coupling group is bound to the disk-shaped core (D), and the right-side of the same is bound to the polymeric radical (P). AL signifies an alkylene group or an alkenylene group, and AR signifies an arylene group. The alkylene group, the alkenylene group, and the arylene group may have a substituent (e.g., an alkyl group).
L1: -AL-CO—O-AL-
L2: -AL-CO—O-AL-O—
L3: -AL-CO—C-AL-C-AL-
L4: -AL-CO—O-AL-O—CO—
L5: —CO-AR—C-AL-
L6: —CO-AR—C-AL-C—
L7: —CO-AR—C-AL-C—CO—
L8: —CO—NH-AL-
L9: —NH-AL-O—
L10: —NH-AL-C—CO—
L11: —O-AL
L12: —C-AL-C—
L13: —O-AL-C—CO—
L14: —O-AL-CO—O—NH-AL-
L15: —C-AL-S-AL-
L16: —C—CO-AR—C-AL-CO—
L17: —O—CO-AR—O-AL-O—CO—
L18: —O—CO-AR—O-AL-O-AL-O—CO—
L10: —O—CO-AR—O-AL-O-AL-O-AL-O—CO—
L20: —S-AL-
L21: —S-AL-C—
L22: —S-AL-C—CO—
L23: —S-AL-S-AL-
L24: —S-AR-AL-

The polymeric radical (P) of formula (3) is determined according to the type of polymerization. An example of the polymeric radical (P) is shown below.

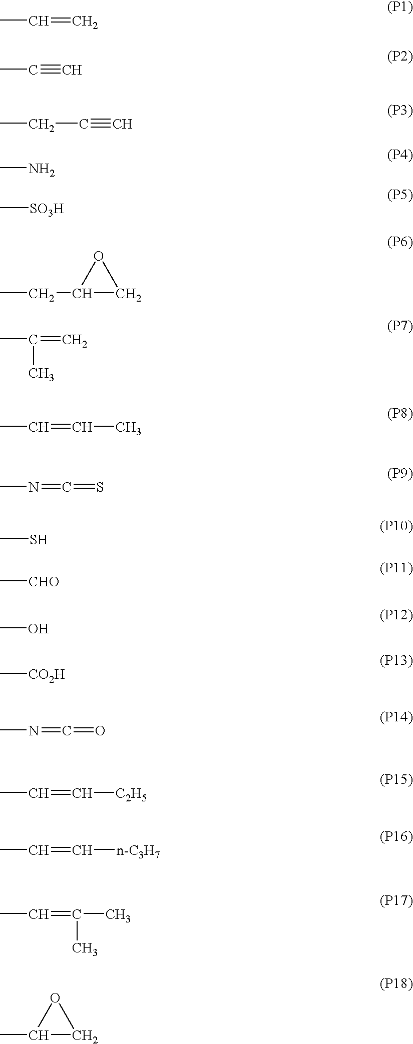

The polymeric radical (P) is preferably unsaturated polymerization radicals (P1, P2, P3, P7, P8, P15, P16, P17) or epoxy radicals (P6, P18), more preferably an unsaturated polymeric radical, and most preferably ethylene unsaturated polymeric radical (P1, P7, P8, P15, P16, P17). As mentioned previously, “n” is an integer from 4 to 12 in formula (3). A specific numeral is determined according to the type of the disk-shaped core (D). Combinations of Land P maybe different but are preferably the same.

When the discotic liquid crystal compound is used, the optical anisotropic layer is a layer having negative birefringence. The surface of the discotic structure unit is preferably tilted with respect to the surface of the cellulose acetate film. Further, an angle made between the surface of the discotic structure unit and the surface of the cellulose acetate film is preferably changed with respect to the depthwise direction of the optical anisotropic layer.

In general, the angle (tilt angle) of the surface of the discotic structure unit increases or decreases in the depthwise direction of the optical anisotropic layer with an increase in the distance from the bottom of the optical anisotropic layer. The tilt angle preferably increases with an increase in distance. A continuous increase, a continuous decrease, an intermittent increase, an intermittent decrease, changing including a continuous increase and a continuous decrease, and an intermittent change including an increase and a decrease can be mentioned as changes in tilt angle. The intermittent change includes a domain at an arbitrary position in the thicknesswise direction, where the tilt angle remains unchanged. Even if the tilt angle the domain where the tilt angle remains unchanged, the entirety of the tilt angle is preferably increased or decreased. Moreover, the entirety of the tilt angle is preferably increased. More preferably, the tilt angle is changed continuously.

The tilt angle of the discotic unit of the support can be generally adjusted by means of selecting material of the discotic liquid crystal compound or material of the alignment film or by means of selecting the rubbing method. Moreover, the tilt angle of the discotic unit on the surface side (air side) thereof can be generally adjusted by means of selecting the discotic liquid crystal compound or another compound to be used with the discotic liquid crystal compound. A plasticizer, a surface active agent, polymeric monomer, polymer, or the like can be enumerated examples of the compound used in conjunction with the discotic liquid crystal compound. In addition, the degree of changes in the tilt angle can also be adjusted by means of the selection similar to that set forth.

As the plasticizer, the surface active agent, or the polymeric monomer used with the discotic liquid crystal compound, any compound can be used so long as it is compatible with the discotic liquid crystal compound and does not make any change in the tilt angle of the discotic liquid crystal compound or hinder orientation. Of the compounds, polymeric monomer (e.g., a vinyl group, a vinyloxy group, an acrylyl group, and a methacryloyl group) is preferable. In general, the content of the above-mentioned compound preferably falls within the range of 1 to 50% by weight and preferably the range of 5 to 30% by weight of the discotic liquid crystal compound.

As polymer used with the discotic liquid crystal compound, any polymer can be used so long as it is compatible with the discotic liquid crystal compound and gives a change in the tilt angle of the discotic liquid crystal compound. Cellulose ester can be provided as an example of polymer. Cellulose acetate, cellulose acetate propionate, hydroxypropylcellulose, and cellulose acetate butyrate can be enumerated as preferred examples of cellulose ester. The content of polymer generally falls within the range of 0.1 to 10% by weight of the discotic liquid crystal compound, preferably within the range of the 0.1 to 8% by weight, and most preferably within the range of 0.1 to 5% by weight.

The optical anisotropic layer is usually obtained by means of applying on the alignment film a solution prepared by dissolving the discotic liquid crystal compound and other compounds, drying the solution, heating the layer to a temperature at which a disconematic phase is formed, and cooling the layer while maintaining the oriented state (i.e., the disconematic phase). Alternatively, the optical anisotropic layer is obtained by means of applying on the alignment film a solution prepared by dissolving the discotic liquid crystal compound and other compounds (e.g., polymeric monomer and a photopolymerization initiator), drying the solution, heating the layer to a temperature at which a disconematic phase is formed, polymerizing the layer (by means of exposure to UV radiation or the like), and cooling the layer. A preferred temperature at which the disconematic liquid crystal phase of the discotic liquid crystal compound used in the present invention transits to a solid phase falls preferably within the range of 70 to 300° C. and particularly 70 to 170° C.

(Fixation of Oriented State of the Liquid Crystal Compound)

The oriented liquid crystal compound can be fixed while maintaining the oriented state thereof. Fixation of the oriented state is preferably performed by means of polymerization. Polymerization includes thermal polymerization reaction using a thermal polymerization initiator and photopolymerization using a photoinitiator. Photopolymerization is preferable. Examples of the photoinitiator include α-carbonylate (described in the specifications of U.S. Pat. Nos. 2,367,661 and 2,367,670), acyloin ether (described in the specification of U.S. Pat. No. 2,448,828), α-hydrocarbon-substituted aromatic acyloin compounds (described in the specification of U.S. Pat. No. 2,722,512), and polynucleus quinone compounds (described in the specification of U.S. Pat. Nos. 3,046,127 and 2,951,758), combinations of triarylimidazole dimer and p-aminophenyl ketone (described in the specification of U.S. Pat. No. 3,549,367), acridine compounds and phenazine compounds (described in the specifications of JP-A-60-105667 and U.S. Pat. No. 4,239,850), and oxadiazole compounds (described in the specification of U.S. Pat. No. 4,212,970).

The quantity of the photoinitiator used preferably falls within the range of 0.01 to 20% by weight of solid of the coating and more preferably within the range of 0.5 to 5% by weight of the same. Use of UV radiation is preferable for polymerizing the liquid crystal compound. Radiation energy preferably falls within the range of 20 mJ/cm² to 50 mJ/cm², more preferably the range of 20 mJ/cm² to 5000 mJ/cm², and most preferably the range of 100 mJ/cm² to 800 mJ/cm². Moreover, radiation may be performed under heating conditions for accelerating photopolymerization.

A protective layer may be provided on the optical anisotropic layer. As mentioned above, the optical compensation sheet can be formed by means of providing the optical anisotropic layer on the cellulose acetate film.

(Liquid Crystal Display)

The polarizing plate formed by bonding the above-mentioned optical compensation sheet to the polarizing layer is advantageously used for a liquid crystal display; particularly, a transmissive liquid crystal display. The transmissive liquid crystal display is formed from a liquid-crystal cell and two polarizing plates arranged on both sides of the liquid crystal cell. The liquid crystal cell holds liquid crystal between two glass plates (electrode substrates). The only requirement is to use the polarizing plate of the present invention as at least one of the two polarizing plates disposed on both sides of the liquid crystal cell. In a liquid crystal cell of TN mode, rod-like liquid crystal molecules are essentially arranged horizontally when no voltage is applied to the cell and also twisted through 60 to 120 degrees. The liquid crystal cell of the TN mode is most frequently used as a color TFT liquid crystal display, which is described in a plurality of documents. Moreover, in addition to being used for the liquid crystal cell of TN mode, the optical compensation sheet of the present invention can be advantageously used for the liquid crystal display, such as an OCB (Optically Compensatory Bend), a VA (Vertically Aligned), and an IPS (In-Plane Switching), as well.

### EXAMPLES

The present invention will be described in detail hereinbelow by reference to embodiments but is not limited to these embodiments.

### Reference Example 1

(Manufacture of a Polarizing Plate Having an Optical Compensation Sheet 1 for TN)

(Manufacture of a Cellulose Acetate Film)

The following compositions were charged into a mixing tank and agitated while being heated, thereby dissolving the ingredients, thereby preparing a cellulose acetate solution (dope).

<Composition of the Cellulose Acetate Solution>

| | |
|---|---|
| cellulose acetate part having an acetification degree | 100 parts by weight |
| of 60.9% | |
| triphenyl phosphate (plasticizer) | 7.8 parts by weight |
| biphenyl diphenyl phosphate (plasticizer) | 3.9 parts by weight |
| methylene chloride (a first solvent) | 250 parts by weight |
| methanol (a second solvent) | 20 parts by weight |

The thus-obtained dope was flowed through use of a band casting machine. The film having 40% by weight of residual solvent was peeled off from the band, conveyed while being exposed to hot wind of 120 ° C. and drawn by 101% in a transport direction, and dried while being spread by 3% in the widthwise direction by means of a tenter. Next, the film was removed from a tenter clip and dried by hot air of 140° C. for 20 minutes, whereby a cellulose acetate film (CF-01) (a thickness of 110 μm) having 0.3% by weight of residual solvent was manufactured.

The thus-formed cellulose acetate film was immersed in a potassium hydroxide solution (25° C.) of 2.0 N in two minutes. Subsequently, the film was neutralized by sulfate, rinsed with pure water, dried, and saponified.

(Formation of the Alignment Film)

A coating solution having the following composition was applied over the formed cellulose acetate film by means of a wire bar coater #14. The coating solution was dried by hot air of 60° C. for 60 seconds and additionally hot air of 90° C. for 150 seconds. Next, the coating was rubbed in a direction parallel to the longitudinal direction of the cellulose acetate film.

<Composition of the Coating Solution of the Alignment Film>

| | |
|---|---|
| denatured polyvinyl alcohol provided below | 20 parts by weight |
| water | 360 parts by weight |
| methanol | 120 parts by weight |
| glutaraldehyde (crosslinking agent) | 1.0 part by weight |
| DENATURED POLYVINYL ALCOHOL | |

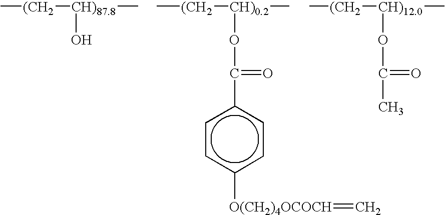

(Formation of the Optical Anisotropic Layer, and Manufacture of the Optical Compensation Sheet)

The following coating solution was applied over the alignment film by an amount of 6.2 cc/m² through use of a wire bar #3.6. The coating solution was prepared by dissolving, into 207g of methyl ethyl ketone, the followings: that is, 91.0 g of discotic (liquid crystal), 9.0 g of ethylene oxide transformation trimethylolpropane triacrylate (V#360 produced by Osaka Organic Chemistry Ltd.), 2.0 g of cellulose acetate butyrates (CAB551-0.2 produced by Eastman Chemical Ltd.), 0.5 g of cellulose acetate butyrate (CAB531-1 produced by Eastman Chemical Ltd.), 3.0 g of photoinitiator (Irgacure 1907 produced by Ciba-Geigy Co., Ltd.), 1.0 g of intensifier (Kayacure DETX produced by Nippon Kayaku Co., Ltd.). This coating solution was heated in a constant temperature zone of 130° C. for two minutes, thereby orienting the discotic compound. Next, the discotic compound was polymerized upon exposure to UV radiation for one minute in the ambient of 60° C. through use of a high-pressure mercury-vapor lamp of 120 W/cm. The discotic compound was then subjected to radiational cooling to room temperature. Thus, the optical anisotropic layer was formed, thereby forming the optical compensation sheet.

The photoelastic coefficient of this film was found to be 12.8×10⁻¹² (1/Pa) by means of the measurement performed by an ellipsometer M-150 manufactured by JASCO Corporation.

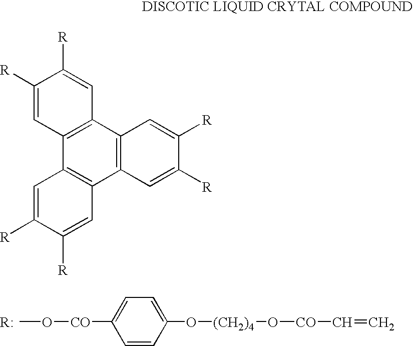

The polarizing layer was formed by causing the drawn polyvinyl alcohol film to adsorb iodine. The thus-formed the optical compensation sheet (RF-01) was subjected to the foregoing saponification processing. Subsequently, the cellulose acetate film was bonded to one side of the polarizing layer so as to come to the polarizing layer side through use of a polyvinyl-alcohol-based adhesive. The penetration axis of the polarizing layer and the lagging axis of the cellulose acetate film were arranged in parallel. A commercially-available cellulose triacetate film (Fuji Tuck TD80UF produced by Fuji Photo Film Ltd.) was subjected to saponification processing, and the film was bonded as a protective film to the side of the polarizing plate opposite the polarizing layer with a polyvinyl-alcohol-based adhesive. Thus, the polarizing plate was manufactured. An acrylic pressure-sensitive adhesive was formed on one side of this polarizing plate so as to assume a thickness of 25 μm after drying, thereby forming a polarizing plate measuring 17 inches such that an absorption axial angle assumes 45 degrees with respect to the side edge of the polarizing plate.

### Reference Example 2

(Manufacture of a Polarizing Plate Having an Optical Compensation Sheet 2 for TN)

(Manufacture of the Cellulose Acetate Film)

The following compositions were charged into the mixing tank and agitated while being heated, thereby dissolving the ingredients, thereby preparing a cellulose acetate solution. <Composition of the Cellulose Acetate Solution>

| | |
|---|---|
| cellulose acetate part having an acetification degree | 100 parts by weight |
| of 60.9% | |
| triphenyl phosphate (plasticizer) | 7.8 parts by weight |
| biphenyl diphenyl phosphate (plasticizer) | 3.9 parts by weight |
| methylene chloride (the first solvent) | 336 parts by weight |
| methanol (the second solvent) | 29 parts by weight |

The thus-obtained dope was flowed through use of the band casting machine. The film having 40% by weight of residual solvent was peeled off from the band, conveyed while being exposed to hot wind of 120° C. and drawn by 101% in the transport direction, and dried while being spread by 3% in the widthwise direction by means of the tenter. Next, the film was removed from the tenter clip and dried by hot air of 140° C. for 20 minutes, whereby a cellulose acetate film (CF-01) (a thickness of 160 μm) having 0.3% by weight of residual solvent was manufactured.

The alignment film and the optical anisotropic layer were formed on the thus-formed cellulose acetate film in the same manner as-described in connection with Reference-Example 1.

The photoelastic coefficient of this film was found to be 15.5×10⁻¹² (1/Pa) by means of the measurement performed by the ellipsometer M-150 manufactured by JASCO Corporation.

The polarizing plate was formed through use of the optical compensation sheet in the same manner as described in connection with Reference Example 1.

### Reference Example 3

(Manufacture of a Polarizing Plate Having an Optical Compensation Sheet 3 for TN)

A norbornene film (having a thickness of 80 μm produced by Zeon Corporation) was subjected to corona discharge, and the alignment film and the optical anisotropic layer were formed on the thus-formed norbornene film in the same manner as described in connection with Reference Example 1.

The photoelastic coefficient of this film was found to be 6.5×10⁻¹² (1/Pa) by means of the measurement performed by the ellipsometer M-150 manufactured by JASCO Corporation.

The thus-formed optical compensation sheet was subjected to corona treatment in place of saponification processing and subjected to the remaining processing in the same manner as that described in connection with Reference Example 1, to thus form a polarizing plate.

### Comparative Example 1

The polarizing plate of Reference Example 1 was bonded to both surfaces of a quartz glass plate (photoelastic coefficient of 3.3×10⁻¹² (1/Pa)) in the form of cross nicol Y value acquired in this case was 40.7.

The glass plate was held in the drier at 60° C. for 17 hours and left on a light table of 2000 cd/m² and observed by the naked eye in a dark room, thereby ascertaining leakage of light. As a result, light leakage was observed on the periphery of the polarizing plate. Moreover, the intensity distribution of the light was measured with a luminance meter, to thus measure the quantity of leaked light. As a result, the maximum leaked light was 0.04%.

### Comparative Example 2

The polarizing plate of Reference Example 2 was bonded to both surfaces of the quartz glass plate (photoelastic coefficient of 3.3×10⁻¹² (1/Pa)) in the form of cross nicol. Y value acquired in this case was 36.4.

The glass plate was held in the drier at 60° C. for one hour and left on the light table of 2000 cd/m² and observed by the naked eye in a dark room, thereby ascertaining leakage of light. As a result, light leakage was observed on the periphery of the polarizing plate. Moreover, the intensity distribution of the light was measured with the luminance meter, to thus measure the quantity of leaked light. As a result, the maximum leakage light was 0.035%.

### Comparative Example 3

The polarizing plate of Reference Example 3 was bonded to both surfaces of a lead glass plate (photoelastic coefficient of 2.9×10⁻¹² (1/Pa)) in the form of cross nicol. Y value acquired in this case was 20.0.

The glass plate was held in the drier at 60° C. for 17 hours and left on the light table of 2000 cd/m² and observed by the naked eye in a dark room, thereby ascertaining leakage of light. As a result, light leakage was observed on the periphery of the polarizing plate. Moreover, the intensity distribution of the light was measured with the luminance meter, to thus measure the quantity of leaked light. As a result, the maximum leaked light was 0.04%.

### Example 1

The polarizing plate of Reference Example 1 was bonded to both surfaces of a pyrex glass plate (photoelastic coefficient of 3.8×10⁻¹² (1/Pa)) in the form of cross nicol. Y value acquired in this case was 35.3.

The glass plate was held in the drier at 60° C. for 17 hours and left on the light table of 2000 cd/m² and observed by the naked eye in a dark room, thereby ascertaining leakage of light. As a result, the light leakage was not observed on the periphery of the polarizing plate. Moreover, the intensity distribution of the light was measured with the luminance meter, to thus measure the quantity of leaked light. As a result, the maximum leakage light was 0.025%.

### Example 2

The polarizing plate of Reference Example 2 was bonded to both surfaces of a pyrex glass plate (photoelastic coefficient of 3.8¹⁰⁻¹² (1/Pa)) in the form of cross nicol. Y value acquired in this case was 31.6.

The glass plate was held in the drier at 60° C. for 17 hours and left on the light table of 2000 cd/m² and observed by the naked eye in a dark room, thereby ascertaining leakage of light. As a result, the light leakage was not observed on the periphery of the polarizing plate. Moreover, the intensity distribution of the light was measured with the luminance meter, to thus measure the quantity of leaked light. As a result, the maximum leakage light was 0.023%.

### Example 3

The polarizing plate of Reference Example 1 was bonded to both surfaces of a borosilicate glass plate (photoelastic coefficient of 4.0×10⁻¹² (1/Pa)) in the form of cross nicol. Y value acquired in this case was 33.6.

The glass plate was held in the drier at 60° C. for 17 hours and left on the light table of 2000 cd/m² and observed by the naked eye in a dark room, thereby ascertaining leakage of light. As a result, the light leakage was not observed on the periphery of the polarizing plate. Moreover, the intensity distribution of the light was measured with the luminance meter, to thus measure the quantity of leaked light. As a result, the maximum leakage light was 0.024%.

### Example 4

The polarizing plate of Reference Example 2 was bonded to both surfaces of a borosilicate glass plate (photoelastic coefficient of 4.0×10⁻¹² (1/Pa)) in the form of cross nicol. Y value acquired in this case was 30.0.

The glass plate was held in the drier at 60° C. for 17 hours and left on the light table of 2000 cd/m² and observed by the naked eye in a dark room, thereby ascertaining leakage of light. As a result, the light leakage was not observed on the periphery of the polarizing plate. Moreover, the intensity distribution of the light was measured with the luminance meter, to thus measure the quantity of leaked light. As a result, the maximum leakage light was 0.022%.

### Example 5

The polarizing plate of Reference Example 3 was bonded to both surfaces of an aluminosilicate glass plate (photoelastic coefficient of 2.6×10⁻¹² (1/Pa)) in the form of cross nicol. Y value acquired in this case was 22.3.

The glass plate was held in the drier at 60° C. for 17 hours and left on the light table of 2000 cd/m² and observed by the naked eye in a dark room, thereby ascertaining leakage of light. As a result, the light leakage was not observed on the periphery of the polarizing plate. Moreover, the intensity distribution of the light was measured with the luminance meter, to thus measure the quantity of leaked light. As a result, the maximum leakage light was 0.025%.

### Example 6

(Optical Compensation Sheet for VA)

The following compositions were charged into the mixing tank and agitated while being heated, thereby dissolving the ingredients, thereby preparing a cellulose acetate solution. <Composition of the Cellulose Acetate Solution>

| | |
|---|---|
| cellulose acetate part having an acetification | 100 parts by weight |
| degree of 60.9% | |
| triphenyl phosphate (plasticizer) | 7.8 parts by weight |
| biphenyl diphenyl phosphate (plasticizer) | 3.9 parts by weight |
| methylene chloride (the first solvent) | 3000 parts by weight |
| methanol (the second solvent) | 54 parts by weight |
| butanol (a third solvent) | 11 parts by weight |

16 parts by weight of the following retardation increasing agent, 80 parts by weight of methylene chloride, and 20 parts by weight of methanol were charged into another mixing tank and agitated while being heated, thereby preparing a retardation increasing solution. 25 parts by weight of retardation increasing agent were mixed in 474 parts by weight of cellulose acetate solution and mixed together. The mixture was sufficiently agitated, thereby preparing a dope. The quantity of retardation increasing agent was 3.5 parts by weight with reference to 100 parts by weight of cellulose acetate.

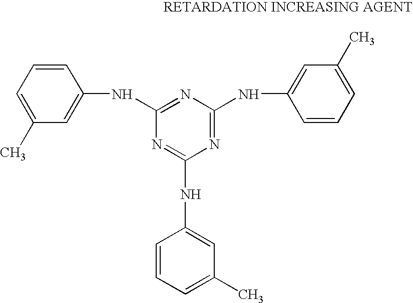

The thus-obtained dope was flowed through use of the band casting machine. The film having 15% by weight of residual solvent was laterally stretched to a stretching scale of 25% at 130° C. through use of the tenter, to thus manufacture the cellulose acetate film (a thickness of 80 μm).

The photoelastic coefficient of this film was found to be 14.0×10⁻¹² (1/Pa) by means of the measurement performed by the ellipsometer M-150 manufactured by JASCO Corporation.

The polarizing layer was formed by causing the drawn polyvinyl alcohol film to adsorb iodine. The thus-formed cellulose triacetate film was subjected to saponification processing, and was bonded to one side of the polarizing plate with a polyvinyl-alcohol-based adhesive. A commercially-available cellulose triacetate film (Fuji Tuck TD80UF produced by Fuji Photo Film Ltd.) was subjected to saponification processing, and the film was bonded as a protective film to the side of the polarizing plate opposite the polarizing layer with a polyvinyl-alcohol-based adhesive. The penetration axis of the polarizing layer and the lagging axis of the thus-formed cellulose acetate film were arranged in parallel. The penetration axis of the polarizing layer and the lagging axis of the cellulose triacetate film were arranged so as to intersect right angles. Thus, the polarizing plate measuring 17 inches was manufactured.

The polarizing plate formed on the pyrex glass plate (having a photoelastic coefficient of 3.8¹⁰⁻¹² (1/Pa)) was put on the observer side of the glass plate by way of one sheet of adhesive such that the cellulose acetate film comes to the liquid crystal cell side of the glass plate. Another commercially-available polarizing plate (HLC2-5618HCS produced by of Sanritz Co. Ltd.) was bonded to the back light side of the glass plate. The polarizing plate was in the form of cross nicol such that the penetration axis of the polarizing layer located on the observer side is oriented vertically and such that the penetration axis of the polarizing plate located on the back light side is oriented horizontally. Y value acquired in this case was 33.

The glass plate was held in the drier at 60° C. for 40 hours and left on the light table of 2000 cd/m² and observed by the naked eye in a dark room, thereby ascertaining leakage of light. The foregoing results show that the light leakage was observed by neither the above-mentioned consequence nor the periphery of the polarizing plate.

### Example 7

(Optical Compensation Sheet for IPS)

170 g of styrenic polymer was dissolved into 830 g of methylene dichloride, wherein 170 g of styrenic polymer is formed as a result of 90 parts by weight of monomer mixture of (B) provided below being graft-polymerized to 10 parts by weight of the copolymer of (A) provided below.
(A) styrene/butadiene copolymer (weight ratio: 20/80)
(B) styrene/acrylonitrile/α-methylstyrene (weight ratio: 60/20/20)

This solution was flowed over the glass plate such that a thickness of 70 μm is obtained after drying. After having been left at room temperature for five minutes, the glass plate was dried in hot air of 45° C. for 20 minutes. The resultantly-obtained film was peeled off from the glass plate. This film was stuck on a rectangular frame and dried for one hour at 70° C. The film was further dried at 110° C. for 15 hours and subjected to uniaxial extension at a scaling factor of 1.9 at 115° C. through use of the tenter. Thus, the uniaxially-stretched film measuring 17 inches consisting of styrene-based polymer was formed. Retardation of the thus-formed film was measured through use of an ellipsometer (AEP-100) manufactured by Shimadzu Ltd. Specifically, Re (1) computed by (nx-ny) xd (nx is a refractive index of the optical anisotropic layer in the direction of the lagging axis thereof within the plane of the optical anisotropic layer; ny is a refractive index of the optical anisotropic layer in the direction of the lagging axis thereof within the plane of the optical anisotropic layer, and “d” is the thickness of the optical anisotropic layer within the plane thereof) was 122 nm, and Re (2) computed by |nx-nz)xd| (nz is a refractive index of the optical anisotropic layer in the thicknesswise direction thereof) was 0 nm. Moreover, the optical axis of the sheet was in the direction parallel to the surface of the film side (i.e., within the plane of the film). The photoelastic coefficient of this film was found to be 12.8×10⁻¹² (1/Pa) by means of the measurement performed by an ellipsometer M-150 manufactured by JASCO Corporation.

The optical compensation sheet formed through the above-mentioned processes was bonded to one side of the pyrex glass plate (a photoelastic coefficient of 3.8×10⁻¹² (1/Pa)), and the polarizing plate was bonded to the optical compensation sheet and the other side of the glass plate in the form of cross nicol, thereby manufacturing the liquid crystal device. In the liquid crystal display, one side of the polarizing plate was arranged such that the penetration axis of the polarizing plate makes an angle of 80 degrees with respect to the longitudinal edge of the glass plate, and the other side of the polarizing plate was arranged such that the penetration axis of the polarizing plate makes an angle of −10 degrees with respect to the longitudinal edge of the glass plate. Moreover, the optical compensation sheet was interposed between the polarizing plate and the liquid crystal cell, an angle made between the penetration axis and the longitudinal edge of the glass plate assuming 80 degrees, such that the optical axis of the optical compensation sheet and the longitudinal edge of the glass plate makes an angle of 80 degrees. Y value acquired in this case-was 28.2.

The glass plate was held in the drier at 60° C. for 40 hours and left on the light table of 2000 cd/m² and observed by the naked eye in a dark room, thereby ascertaining leakage of light. As a result, the light leakage was not observed on the periphery of the polarizing plate.

From the foregoing examples and comparative examples, a high-display-quality liquid crystal display can be evidently obtained without inducing light leakage, which would otherwise be caused by thermal distortion, by means of setting the Y value of the optical compensation sheet to a value of 22 or more and less than 36.

The present application claims foreign priority based on Japanese Patent Application No. JP2003-383828, filed Nov. 13, 2003, the contents of which is incorporated herein by reference.

1. An optical compensation sheet for a liquid crystal display, the liquid crystal display comprising: a liquid crystal cell having a glass plate; and a polarizing plate having the optical compensation film faced to the glass plate,
wherein the optical compensation sheet has a thickness by μm and a first photoelastic coefficient by 1/Pa; the glass plate has a second photoelastic coefficient by 1/Pa; and the thickness, the first photoelastic coefficient and the second photoelastic coefficient satisfy a condition that a value Y determined as a result of division of a product of a square root of the thickness and the first photoelastic coefficient by the second photoelastic coefficient is a value of 22 or more and less than 36.

2. The optical compensation sheet according to claim 1, which comprises a polymer film.

3. The optical compensation sheet according to claim 2, wherein the polymer film comprises a triacetylcellulose film.

4. The optical compensation sheet according to claim 2, wherein the polymer film comprises a polymer film of norbornenes.

5. The optical compensation sheet according to claim 2, wherein the polymer film comprises a styrenic polymer film.

6. The optical compensation sheet according to claim 1, which comprises: a transparent support; and an optical anisotropic layer formed from a liquid crystal compound.

7. A polarizing plate for a liquid crystal display, the liquid crystal display comprising: a liquid crystal cell having a glass plate; and the polarizing plate,
the polarizing plate comprising: a transparent protective film; a polarizing layer; and an optical compensation film an optical compensation film faced to the glass plate in this order,
wherein the optical compensation sheet has a thickness by μm and a first photoelastic coefficient by 1/Pa; the glass plate has a second photoelastic coefficient by 1/Pa; and the thickness, the first photoelastic coefficient and the second photoelastic coefficient satisfy a condition that a value Y determined as a result of division of a product of a square root of the thickness and the first photoelastic coefficient by the second photoelastic coefficient is a value of 22 or more and less than 36.

8. A liquid crystal display comprising:
a liquid cell having a glass plate; and
a polarizing layer having an optical compensation film faced to the glass plate,
wherein the optical compensation sheet has a thickness by μm and a first photoelastic coefficient by 1/Pa; the glass plate has a second photoelastic coefficient by 1/Pa; and the thickness, the first photoelastic coefficient and the second photoelastic coefficient satisfy a condition that a value Y determined as a result of division of a product of a square root of the thickness and the first photoelastic coefficient by the second photoelastic coefficient is a value of 22 or more and less than 36.

9. The liquid crystal display according to claim 8, wherein-the optical compensation sheet comprises a polymer film.

10. The liquid crystal display according to claim 9, wherein the polymer film comprises a triacetylcellulose film.

11. The liquid crystal display according to claim 9, wherein the polymer film comprises a polymer film of norbornenes.

12. The liquid crystal display according to claim 9, wherein the polymer film comprises a styrenic polymer film.

13. The liquid crystal display according to claim 8, which the optical compensation sheet comprises: a transparent support; and an optical anisotropic layer formed from a liquid crystal compound.

14. The liquid crystal display according to claim 8, wherein the glass plate comprises at least one selected from the group consisting of quartz glass, pyrex glass, borosilicate glass, vycor glass, soda lime glass, aluminosilicate glass, lead glass, and non-alkali glass.

15. The liquid crystal display according to claim 8, wherein the glass plate comprises at least one selected from the group consisting of pyrex glass, borosilicate glass, and aluminosilicate glass.

16. The liquid crystal display according to claim 8, which has an light leakage quantity of 0.03% or less.
